(19) United States
(12) Patent Application Publication
(10) Pub. No.: US 2025/0370957 A1
(43) Pub. Date: Dec. 4, 2025

(54) EFFICIENT CREATION OF BUCKET-LEVEL SNAPSHOTS AND EFFICIENT SNAPSHOT PROTECTION DETERMINATION

(71) Applicant: NetApp, Inc., San Jose, CA (US)

(72) Inventors: Jessica Peters, North Vancouver (CA); Wenxin Zhou, Surrey (CA); Galan Enzinger, Ucluelet (CA); Brad Lisson, Pitt Meadows (CA)

(73) Assignee: NetApp, Inc., San Jose, CA (US)

(21) Appl. No.: 19/223,260

(22) Filed: May 30, 2025

Related U.S. Application Data
(60) Provisional application No. 63/654,388, filed on May 31, 2024.

(51) Int. Cl. G06F 16/11; G06F 16/13; G06F 16/18

(52) U.S. Cl. CPC G06F 16/128; G06F 16/13; G06F 16/1873

(57) ABSTRACT

Systems and methods for creation of bucket-level snapshots and snapshot ownership determination are provided. In one example, a storage system maintains a bucket containing multiple objects each having one or more object versions. A snapshot of the bucket may be efficiently created to protect object versions in the bucket at a specific point in time by simply adding an entry, containing information regarding a snapshot identifier (ID) and a snapshot creation time indicator, to a snapshot metafile. Object-modifying operations may be hooked to internally modify them while making it appear to the client the operation has been successfully completed. For example, before deletion of a particular object, an “Is-Object-Protected” check may be performed based on time indicators of the one or more object versions and respective snapshot creation time indicators. When the particular object is protected, it may be subsequently hidden from the client but maintained as an internal version.

### CROSS-REFERENCE TO RELATED PATENTS

This application claims the benefit of priority to U.S. Provisional Application No. 63/654,388 filed on May 31, 2024, which is hereby incorporated by reference in its entirety for all purposes.

### FIELD

Various embodiments of the present disclosure generally relate to storage systems. In particular, some embodiments relate to technology approaches for taking a snapshot of a bucket (e.g., an object-based storage resource) and determining whether an object version is protected by or “owned” by an existing snapshot of the bucket.

### BACKGROUND

In some cloud storage services, data is stored as objects within storage resources. Object protocols (or object storage protocols) (e.g., Amazon's Simple Storage Service (S3) protocol) may be used for interfacing with object storage over a network, by using buckets, keys and operations. Object protocols may use versioning to keep multiple versions of an object in a bucket, thereby allowing a client-side restore of a previous version of an object, for example, that has been accidently overwritten (but has not been deleted) by allowing the client to read previous version(s) and create a new version with the same contents of the desired previous version.

A snapshot typically represents a space-efficient, read-only, point-in-time image or reference point created at a particular time that preserves the state of a system, server, or volume. Snapshots may be used for various purposes, including data protection, disaster recovery, testing, and reverting to a previous state. Snapshots are generally available in storage products for file protocols, thereby allowing an administrator of a storage system to create recovery points for a data set and thereafter perform a restoration to a known good state in case of, among other things, accidental deletion, corruption, or ransomware attacks. Traditional object storage products (e.g., object storage services, such as Amazon S3, Google Cloud Storage, and the like), however, typically place the burden of performing backup and data recovery on the client application making use of the object storage product, for example, requiring the client application to traverse all objects in a bucket to catalog the object versions in the bucket to perform backup and recovery operations.

### BRIEF DESCRIPTION OF THE DRAWINGS

The present disclosure is best understood from the following detailed description when read with the accompanying figures.

FIG. 1 is a block diagram illustrating an example of a distributed storage system in accordance with one or more embodiments.

FIG. 2 is a block diagram illustrating an example on-premise environment in which various embodiments may be implemented.

FIG. 3 is a block diagram illustrating an example cloud environment in which various embodiments may be implemented.

FIG. 4 illustrates an example multitiered namespace built from a changing collection of small variable length databases in accordance with one embodiment.

FIG. 5 illustrates a tree of objects without object versioning.

FIG. 6 illustrates one approach for representing object versions within a V+ tree by including a version ID in chapter object records.

FIG. 7 illustrates an example approach for representing object versions within a V+ tree in accordance with one or more embodiments.

FIG. 8 is a block diagram illustrating an example chapter record and an example version table in accordance with one or more embodiments.

FIG. 9 is a block diagram illustrating an example scenario involving creation of a snapshot of an unversioned bucket and the impact of subsequent object overwrites in accordance with one or more embodiments.

FIGS. 10A-10B are block diagrams illustrating an example scenario involving creation of snapshots of a versioned bucket and the impact of subsequent deletion of various object versions in accordance with one or more embodiments.

FIG. 11 is a table illustrating another example scenario of a possible object version workflow for a versioning-enabled bucket in accordance with one or more embodiments.

FIG. 12 conceptually illustrates an example of a snapshot metafile in accordance with one or more embodiments.

FIG. 13 is a flow diagram illustrating operations associated with snapshot creation in accordance with one or more embodiments.

FIG. 14 is a flow diagram illustrating operations associated with performing a snapshot protection determination for a particular version of an object in accordance with one or more embodiments.

FIGS. 15A-15C are block diagrams illustrating various scenarios and the state of an object before and after performing a snapshot restore in accordance with one or more embodiments.

FIG. 16 is a flow diagram illustrating operations associated with performing a snapshot restore that appears instantaneously and immediately consistent from a client perspective in accordance with one or more embodiments.

FIG. 17 is a flow diagram illustrating operations associated with performing flexible object selection in connection with an operation relating to a snapshot in accordance with one or more embodiments.

FIG. 18 conceptually illustrates another example of a snapshot metafile in accordance with one or more embodiments.

FIG. 19 is a block diagram illustrating an example of a network environment in accordance with one or more embodiments.

FIG. 20 is a block diagram conceptually illustrating various functional units of a storage system that may be used to implement bucket-level snapshots in accordance with one or more embodiments.

FIG. 21 illustrates an example computer system in which or with which embodiments of the present disclosure may be utilized.

The drawings have not necessarily been drawn to scale. Similarly, some components and/or operations may be separated into different blocks or combined into single blocks for the purposes of discussion of some embodiments of the present technology. Moreover, while the technology is amenable to various modifications and alternate forms, specific embodiments have been shown by way of example in the drawings and are described in detail below. The intention, however, is not to limit the technology to the particular embodiments described or shown. On the contrary, the technology is intended to cover all modifications, equivalents, and alternatives falling within the scope of the technology as defined by the appended claims.

### SUMMARY

Systems and methods are described for creation of bucket-level snapshots and snapshot protection determination. According to one embodiment, a storage system maintains a bucket containing multiple objects each having one or more object versions. A snapshot of the bucket is created by adding a snapshot entry, including a snapshot identifier (ID) and a snapshot time indicator, to a snapshot metafile. After creation of the snapshot, those of the one or more object versions of respective objects existing at a specific point in time indicated by the snapshot time indicator are protected.

According to another embodiment, a storage system maintains a bucket containing a multiple objects each having one or more object versions. The storage system also maintains a snapshot metafile having a snapshot entry for each snapshot of multiple snapshots of the bucket in which a given snapshot entry includes a snapshot identifier (ID) and a snapshot time indicator. After receiving a request that would result in deletion of a particular version of the one or more object versions of a given object, prior to deleting the particular version, the storage system determines whether the particular version is protected by one or more snapshots by comparing one or more time indicators of the particular version to the respective snapshot time indicators of the one or more snapshot entries for the one or more snapshots.

Other features of embodiments of the present disclosure will be apparent from accompanying drawings and detailed description that follows.

### DETAILED DESCRIPTION

Systems and methods are described for creation of bucket-level snapshots and snapshot protection determination. As noted above, while snapshots are generally available in storage products for file protocols, traditional object storage products do not provide native support for bucket-level snapshots and place the burden of performing backup and data recovery on a client application making use of the object storage product. While an S3 bucket is a non-limiting example of an object-based storage resource that may serve as a container for storing objects, the term bucket and object-based storage resource may be used interchangeably throughout this specification.

Various embodiments described herein provide the ability to, among other things, create, browse, delete, and restore snapshots of a bucket. While the semantics may generally parallel those relating to snapshots for file protocols, the underlying mechanisms used to take snapshots of a bucket and to subsequently protect objects “owned by” a given snapshot at the whole-object level is very different. For example, for files, a snapshot is a low-level consistency point and individual block overwrites are allowed, while, for objects, a snapshot may be represented in the form of a metafile entry and object-modifying operations may be explicitly hooked to internally modify them at the whole-object level as appropriate (e.g., by retaining hidden or internal versions) while making it appear to the client the object-modifying operation has been successfully completed.

As described further below, according to one embodiment, a storage system maintains a bucket containing multiple objects each of which has one or more object versions. A snapshot of the bucket may be efficiently created to protect object versions in the bucket at a specific point in time by simply adding an entry, containing information regarding a snapshot identifier (ID) (e.g., in the form of a name and/or universally unique ID (UUID)) and a snapshot time indicator (e.g., in the form of a timestamp or a monotonically increasing epoch that is kept consistent across a storage cluster), to a snapshot metafile (or a data structure used for storing metadata associated with the snapshot). For example, a snapshot of the bucket may be taken natively by the storage system and built into the bucket, making the snapshot creation instantaneous, as described further below. After creation of the snapshot, the storage system, thereafter protects those of the one or more object versions of objects “owned by” the snapshot (i.e., the then current versions of the one or more object versions existing at a specific point in time indicated by the snapshot time indicator).

Turning now to object protection, in one embodiment, a snapshot entry is maintained within a snapshot metafile by a storage system for each snapshot of multiple snapshots of a bucket in which the snapshot entry includes a snapshot identifier (ID) and a snapshot time indicator. When the storage system receives a request that would result in deletion of a particular version of a given object, prior to deleting the particular version, it is determined whether the particular version is protected by (or owned by) one or more existing snapshots of the bucket by comparing one or more time indicators (e.g., a creation time and a deletion time) of one or more versions (including the particular version) to the respective snapshot creation time indicators of the one or more snapshot entries corresponding to the one or more existing snapshots.

With respect to snapshot restoration, while existing third-party tools can crawl a bucket at a point in time and one-by-one modify the objects to make them appear like that point in time, there are at least two major disadvantages to such existing solutions. First, the snapshot restoration is not instantaneous and therefore clients will see the restore process happening gradually on an object-by-object basis. Second, such existing solutions are incapable of restoring back to object versions that are no longer visible to a client. This is because existing solutions do not offer protection on behalf of a client and therefore object versions that have been deleted by a client cannot be recovered.

Embodiments described herein, address both of these limitations. For example, in one embodiment, a storage system, may restore a previous version of one or more objects to the bucket based on a snapshot of the bucket by performing a background restore process. During the background restore process, the restoration of the previous version of the one or more objects is made to appear instant to a client. For example, during the background restore process, object accesses by the client associated with a read-only operation may be redirected to content of the snapshot. Additionally or alternatively, during the background restore process, prior to acting on a request from the client involving an object-modifying operation relating to a particular object of the one or more objects, the previous version of the particular object may be restored on-demand.

With respect to the ability of various embodiments to restore back to object versions that are no longer visible to a client, in one embodiment, this is a result of protections that may be performed on behalf of a client by maintaining hidden versions (or internal versions) of objects that have been deleted (e.g., by a lifecycle policy or by a client). For example, as described further below, the storage system, may maintain a prior version table (or any other data structure) for each object in a bucket containing information relating to one or more object versions of the object that represent prior versions. As such, during performance of a restore operation based on a particular snapshot of the bucket, the storage system may iterate over each object version of the one or more object versions maintained in the prior version table for each of the one or more objects and during the iterating, the storage system may make the object version visible by removing a deletion time indicator associated with the object version based on (i) the object version representing a hidden version having a time indicator prior to the snapshot time indicator of the snapshot entry corresponding to the particular snapshot and (ii) the hidden version representing a correct current version according to the snapshot time indicator of the snapshot entry corresponding to the particular snapshot.

In other examples, the storage system may support granular snapshots. For example, as described further below, the storage system, may limit a scope of an operation relating to a snapshot of the bucket by applying a snapshot filter associated with the snapshot. The filter specifies one or more criteria for determining those of the plurality of objects to which the snapshot applies. According to one embodiment, the snapshot filter may be stored within the snapshot entry of the snapshot metafile corresponding to the snapshot. Those skilled in the art will appreciate an association may be made between a snapshot filter and a given snapshot in various other ways, for example, via a data structure stored in memory.

While various examples may be described with reference to S3 buckets, it is to be appreciated the methodologies described herein are equally applicable to other object-based storage resources or containers for storing objects, for example, including, but not limited to a storage operating system Network Attached Storage (NAS) buckets. Similarly, while various examples may be described with reference to versioned buckets, it is to be appreciated the methodologies described herein are equally applicable to unversioned buckets, which may internally use versioning infrastructure but be marked as “internally versioned” so that they can be presented to clients as unversioned. Additionally, while various examples may be described with reference to use of a snapshot time indicator in the form of an absolute time (e.g., a timestamp), it is to be appreciated the snapshot time indicator may alternatively represent a relative time (e.g., a monotonically increasing counter in the form of an epoch) to address perceived issues relating to time skew among multiple nodes of a distributed storage system.

In the following description, numerous specific details are set forth in order to provide a thorough understanding of embodiments of the present disclosure. It will be apparent, however, to one skilled in the art that embodiments of the present disclosure may be practiced without some of these specific details. In other instances, well-known structures and devices are shown in block diagram form.

### Terminology

Brief definitions of terms used throughout this application are given below.

A “computer” or “computer system” may be one or more physical computers, virtual computers, or computing devices. As an example, a computer may be one or more server computers, cloud-based computers, cloud-based cluster of computers, virtual machine instances or virtual machine computing elements such as virtual processors, storage and memory, data centers, storage devices, desktop computers, laptop computers, mobile devices, or any other special-purpose computing devices. Any reference to “a computer” or “a computer system” herein may mean one or more computers, unless expressly stated otherwise.

The terms “component”, “module”, “system,” and the like as used herein are intended to refer to a computer-related entity, either software-executing general-purpose processor, hardware, firmware and a combination thereof. For example, a component may be, but is not limited to being, a process running on a hardware processor, a hardware processor, an object, an executable, a thread of execution, a program, and/or a computer. By way of illustration, both an application running on a server and the server can be a component. One or more components may reside within a process and/or thread of execution, and a component may be localized on one computer and/or distributed between two or more computers. Also, these components can be executed from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

The term file/files as used herein include data container/data containers, directory/directories, and/or data object/data objects with structured or unstructured data. Some files may be used to store client data and other files (e.g., metafiles) may be used to store metadata used by the storage operating system.

As used herein, an “index node” or “inode” generally refers to a file data structure maintained by a file system that stores metadata for data containers (e.g., directories, subdirectories, files, objects, etc.). An inode may include, among other things, location, file size, permissions needed to access a given file with which it is associated as well as creation, read, and write timestamps, and one or more flags.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

As used herein, a “cloud” or “cloud environment” broadly and generally refers to a platform through which cloud computing may be delivered via a public network (e.g., the Internet) and/or a private network. The National Institute of Standards and Technology (NIST) defines cloud computing as “a model for enabling ubiquitous, convenient, on-demand network access to a shared pool of configurable computing resources (e.g., networks, servers, storage, applications, and services) that can be rapidly provisioned and released with minimal management effort or service provider interaction.” P. Mell, T. Grance, The NIST Definition of Cloud Computing, National Institute of Standards and Technology, USA, 2011. The infrastructure of a cloud may be deployed in accordance with various deployment models, including private cloud, community cloud, public cloud, and hybrid cloud. In the private cloud deployment model, the cloud infrastructure is provisioned for exclusive use by a single organization comprising multiple consumers (e.g., business units), may be owned, managed, and operated by the organization, a third party, or some combination of them, and may exist on or off premises. In the community cloud deployment model, the cloud infrastructure is provisioned for exclusive use by a specific community of consumers from organizations that have shared concerns (e.g., mission, security requirements, policy, and compliance considerations), may be owned, managed, and operated by one or more of the organizations in the community, a third party, or some combination of them, and may exist on or off premises. In the public cloud deployment model, the cloud infrastructure is provisioned for open use by the general public, may be owned, managed, and operated by a cloud provider (e.g., a business, academic, or government organization, or some combination of them), and exists on the premises of the cloud provider. The cloud service provider may offer a cloud-based platform, infrastructure, application, or storage services as-a-service, in accordance with a number of service models, including Software-as-a-Service (SaaS), Platform-as-a-Service (PaaS), and/or Infrastructure-as-a-Service (IaaS). In the hybrid cloud deployment model, the cloud infrastructure is a composition of two or more distinct cloud infrastructures (private, community, or public) that remain unique entities, but are bound together by standardized or proprietary technology that enables data and application portability (e.g., cloud bursting for load balancing between clouds).

As used herein, a “storage system” or “storage appliance” generally refers to a type of computing appliance or node, in virtual or physical form, that provides data to, or manages data for, other computing devices or clients (e.g., applications). As such, a storage system may also be referred to herein as a server or a storage server. The storage system may be part of a cluster of multiple nodes representing a distributed storage system. In various examples described herein, a storage system may be run (e.g., on a VM or as a containerized instance, as the case may be) within a public cloud provider.

As used herein, the term “storage operating system” generally refers to computer-executable code operable on a computer to perform a storage function that manages data access and may, in the case of a storage system (e.g., a node), implement data access semantics of a general purpose operating system. The storage operating system can also be implemented as a microkernel, an application program operating over a general-purpose operating system, such as UNIX or Windows NT, or as a general-purpose operating system with configurable functionality, which is configured for storage applications as described herein.

As used herein, a “storage volume” or “volume” generally refers to a container in which applications, databases, and file systems store data. A volume is a logical component created for the host to access storage on a storage array. A volume may be created from the capacity available in storage pod, a pool, or a volume group. A volume has a defined capacity. Although a volume might consist of more than one drive, a volume appears as one logical component to the host. Non-limiting examples of a volume include a flexible volume and a flexgroup volume.

As used herein, a “flexible volume” generally refers to a type of storage volume that may be efficiently distributed across multiple storage devices. A flexible volume may be capable of being resized to meet changing business or application requirements. In some embodiments, a storage system may provide one or more aggregates and one or more storage volumes distributed across a plurality of nodes interconnected as a cluster. Each of the storage volumes may be configured to store data such as files and logical units. As such, in some embodiments, a flexible volume may be comprised within a storage aggregate and further comprises at least one storage device. The storage aggregate may be abstracted over a RAID plex where each plex comprises a RAID group. Moreover, each RAID group may comprise a plurality of storage disks. As such, a flexible volume may comprise data storage spread over multiple storage disks or devices. A flexible volume may be loosely coupled to its containing aggregate. A flexible volume can share its containing aggregate with other flexible volumes. Thus, a single aggregate can be the shared source of all the storage used by all the flexible volumes contained by that aggregate. A non-limiting example of a flexible volume is a NetApp ONTAP Flex Vol volume (without derogation of any trademark rights of NetApp Inc., the assignee of this application).

As used herein, a “flexgroup volume” generally refers to a single namespace that is made up of multiple constituent/member volumes. A non-limiting example of a flexgroup volume is a NetApp ONTAP FlexGroup volume that can be managed by storage administrators, and which acts like a NetApp Flex Vol volume. In the context of a flexgroup volume, “constituent volume” and “member volume” are interchangeable terms that refer to the underlying volumes (e.g., flexible volumes) that make up the flexgroup volume.

As used herein, a “cloud volume” generally refers to persistent storage that is accessible to a virtual storage system by virtue of the persistent storage being associated with a compute instance in which the virtual storage system is running. A cloud volume may represent a hard-disk drive (HDD) or a solid-state drive (SSD) from a pool of storage devices (or “disks” which is used interchangeably throughout this specification) within a cloud environment that is connected to the compute instance through Ethernet or fibre channel (FC) switches as is the case for network-attached storage (NAS) or a storage area network (SAN). Non-limiting examples of cloud volumes include various types of SSD volumes (e.g., AWS Elastic Block Store (EBS) gp2, gp3, io1, and io2 volumes for EC2 instances) and various types of HDD volumes (e.g., AWS EBS st1 and sc1 volumes for EC2 instances).

As used herein, a “V+ tree” generally refers to an m-ary tree data structure with a variable number of children per node. A V+ tree consists of a root, internal nodes, and leaves. A V+ tree can be viewed as a B+ tree in which the keys contained within the nodes are variable length.

As used herein, an “object” generally refers to the fundamental unit of data storage used by object storage. An object may encapsulate structured or unstructured data of arbitrary size. For example, an object may represent any type of file or data (e.g., images, videos, documents, etc.). An object may also include or otherwise be associated with metadata, which provides descriptive information (e.g., a key, such as a name or unique identifier, size, creation time, and/or tags). Each “version” of an object, for example, stored within a versioned bucket is also considered an object in which the most recent version is considered the current version of the object.

As used herein, a “bucket” generally refers to any object-based storage resource or container for storing objects. A non-limiting example of a bucket is an S3 bucket.

As used herein, a “bucket-level snapshot,” or simply a “snapshot” generally refers to a point-in-time snapshot of a bucket that captures and protects all or a subset of current object versions of respective objects stored in the bucket as of a creation time indicator associated with the snapshot, for example, at the timestamp at which a non-retroactive snapshot is taken or at the timestamp in the past for which a retroactive snapshot has been retroactively defined. While various examples described herein may be described with reference to snapshots containing timestamps, the term snapshot is intended to encompass both a timestamp snapshot (a snapshot defined at least in part by a creation timestamp) and an epoch snapshot (a snapshot defined at least in part by a creation epoch).

As used herein, a “hidden version” or an “internal version” of an object generally refers to a version of an object that has been deleted, implicitly or explicitly, by a client or by a lifecycle policy, but that is nevertheless retained by a storage system because the version of the object is protected by an existing snapshot of the bucket in which the object is stored. Hidden or internal versions of objects are generally not visible to a client and are generally treated as if they do not exist. For example, a hidden or internal version of an object is not presented or otherwise displayed to a client in connection with operations associated with the bucket or the object; however, a hidden or internal version is displayed to a client when the client is browsing the snapshot (e.g., via a snapshot “pseudo-bucket”), which allows the client to see the contents of the snapshot. A hidden or internal version of an object may become unhidden or made visible and be promoted to the new current version of the object if and when a snapshot that protects the hidden or internal version of the object is restored. In examples described herein, after the last snapshot is deleted that protects a hidden or an internal version of an object, the hidden version of the object is permanently deleted as the hidden or internal version is no longer of use given it can no longer be restored. As will be appreciated by those skilled in the art, the term “client” when used in certain contexts, for example, relating to hidden or internal versions of objects, includes both client applications of the storage system as well as human users (e.g., a storage administrator) of the storage system.

Herein, a given version of an object may be said to be “owned by,” “protected by,” or “captured by” a snapshot when the given version of the object was the current version of the object as of a creation time associated with the snapshot. In various examples described herein, only the current versions of respective objects associated with a given bucket are protected by a snapshot. That is, a snapshot does not protect the object history including prior versions existing as of the creation time associated with the snapshot. In one embodiment, an efficient determination regarding whether a given object version is protected by an existing snapshot may be performed with simple application of greater than or equal and less than or equal time indicator comparisons between one or more time indicators (e.g., a creation time and a deletion time, if any) associated with the given object and the creation time of the existing snapshot. For example, as described further below, an “Is-Object-Protected” check may be performed with reference to a snapshot metafile associated with the bucket containing information regarding all existing snapshots of the bucket by iterating through all existing snapshots and comparing the creation time of the snapshot at issue to the creation time and the deletion time (if any) of the given object version. If the creation time of the snapshot at issue is equal to or after the creation time of the given object and equal to or before the deletion time of the given object, and the given version of the object was the current version—had the latest creation time among all existing client-visible versions of the object—as of the creation time of the snapshot at issue, then the given object is protected by the snapshot at issue; otherwise, the given object is not protected by the snapshot at issue.

As used herein, a “granular snapshot” generally refers to a snapshot having an associated snapshot filter that limits the scope of operations performed relating to the snapshot. As described further below, in one embodiment, the snapshot filter may be based on any attribute of an object that is immutable or a combination of such attributes. In one example, the associated snapshot filter may be included within a corresponding snapshot entry of a snapshot metafile.

As used herein, a “snapshot identifier” or “snapshot ID” generally refers to a unique identifier associated with a snapshot. Depending on the particular implementation, the unique identifier may be in the form of a client-specified or automatically generated snapshot name, a storage system generated universally unique ID (UUID), or some combination thereof.

As used herein, a “snapshot time indicator” generally refers to a creation time associated with a snapshot in the form of an absolute time (e.g., a timestamp) or a relative time (e.g., a monotonically increasing counter in the form of an epoch). As noted above, for timestamp snapshots, the creation time may be a timestamp in the past for which a retroactive snapshot is to be captured.

As used herein, a “metafile” generally refers to a file or a data structure containing metadata that is used internally by the storage system.

As used herein, a “snapshot metafile” generally refers to a metafile that maintains metadata relating to one or more snapshots. While various examples described herein assume the use of a snapshot metafile to track snapshot entries (e.g., containing respective snapshot names and snapshot creation times) corresponding to existing snapshots of a given bucket, those skilled in the art will appreciate such snapshot entries may be maintained in other ways, for example, within a data structure stored in memory.

The number of files or objects a storage volume can contain may be determined by how many inodes it has. An inode is a data structure that represents a file or object in a storage system and stores metadata of the file/object such as timestamps and permissions. An inode may include a pointer to the data blocks that make up any file, folder, or object within the storage system, including snapshot copies. A storage volume may include both private and public inodes. Public inodes are used for files visible to the user; private inodes are used for files that are used internally by the storage system. The maximum number of public inodes for a volume may be adjusted by the system administrator, but the number of private inodes may not be adjusted by the system administrator. A file that is sufficiently small (e.g., less than 64 bytes) may be stored in the inode itself and does not use additional storage capacity.

Tags, user-specified metadata, and some system metadata that may not be stored in the inode may be stored as inode labels. Each version of an object may have tags and metadata. This may be the case for both versioned buckets, and unversioned buckets, which the storage system may treat as internally versioned. Each object and previous version is a different inode and may have separate inode labels. The storage system ensures that inode labels are not deleted as long as the inodes themselves are protected. User-specified and system metadata are immutable once created, so there may be only one version to save. Tags, including tags on previous versions, may be mutable. If tags are modified on an object that is stored in a previous snapshot, the storage system may need to keep copies of the tags so that previous versions may be available. If additional information is identified that should be captured per-snapshot, it may be stored in a “snapshot” metafile keyed by bucket and a snapshot time indicator (e.g., a snapshot timestamp or epoch).

As described further below, in some examples, the namespace of objects is organized by Table of Contents (TOC) and chapters. The object versioning information may be stored in a metafile called prior version table (“PVT”), which stores pointers to non-current objects.

### Example High-Level View of a Distributed Storage System

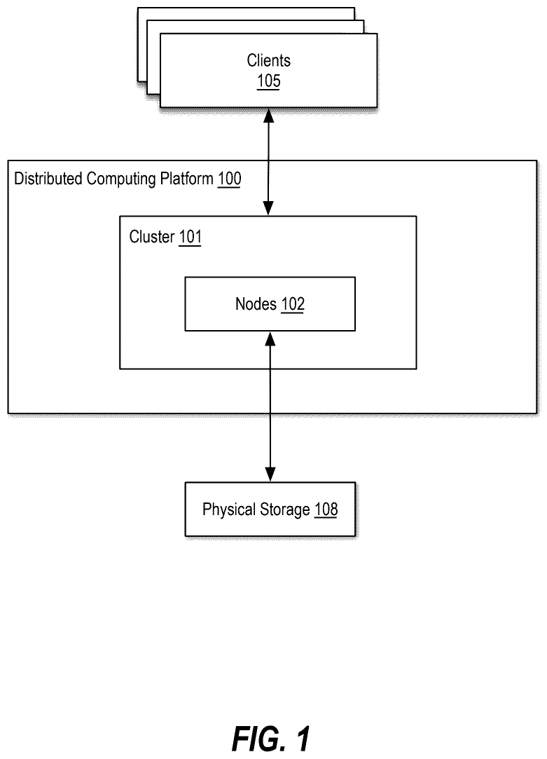

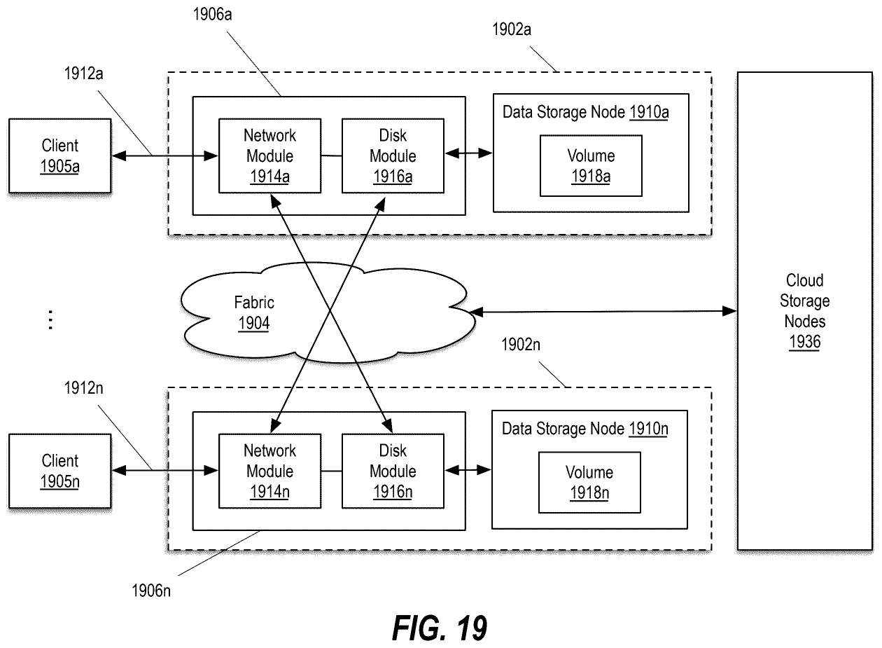

FIG. 1 is a block diagram illustrating an example of a distributed storage system (e.g., cluster 101) within a distributed computing platform 100 in accordance with one or more embodiments. In one or more embodiments, the distributed storage system may be implemented at least partially virtually. In the context of the present example, the distributed computing platform 100 includes a cluster 101. Cluster 101 includes multiple nodes 102. In one or more embodiments, nodes 102 include two or more nodes. A non-limiting example of a way in which cluster 101 of nodes 102 may be implemented is described in further detail below with reference to FIG. 19.

Nodes 102 may service read requests, write requests, or both received from one or more clients (e.g., clients 105). In one or more embodiments, one of nodes 102 may serve as a backup node for the other should the former experience a failover event. Nodes 102 are supported by physical storage 108. In one or more embodiments, at least a portion of physical storage 108 is distributed across nodes 102, which may connect with physical storage 108 via respective controllers (not shown). The controllers may be implemented using hardware, software, firmware, or a combination thereof. In one or more embodiments, the controllers are implemented in an operating system within the nodes 102. The operating system may be, for example, a storage operating system (OS) that is hosted by the distributed storage system. Physical storage 108 may be comprised of any number of physical data storage devices. For example, without limitation, physical storage 108 may include disks or arrays of disks, solid state drives (SSDs), flash memory, one or more other forms of data storage, or a combination thereof associated with respective nodes. For example, a portion of physical storage 108 may be integrated with or coupled to one or more nodes 102.

In some embodiments, nodes 102 connect with or share a common portion of physical storage 108. In other embodiments, nodes 102 do not share storage. For example, one node may read from and write to a first portion of physical storage 108, while another node may read from and write to a second portion of physical storage 108.

Should one of the nodes 102 experience a failover event, a peer high-availability (HA) node of nodes 102 can take over data services (e.g., reads, writes, etc.) for the failed node. In one or more embodiments, this takeover may include taking over a portion of physical storage 108 originally assigned to the failed node or providing data services (e.g., reads, writes) from another portion of physical storage 108, which may include a mirror or copy of the data stored in the portion of physical storage 108 assigned to the failed node. In some cases, this takeover may last only until the failed node returns to being functional, online, or otherwise available.

### Example Operating Environment

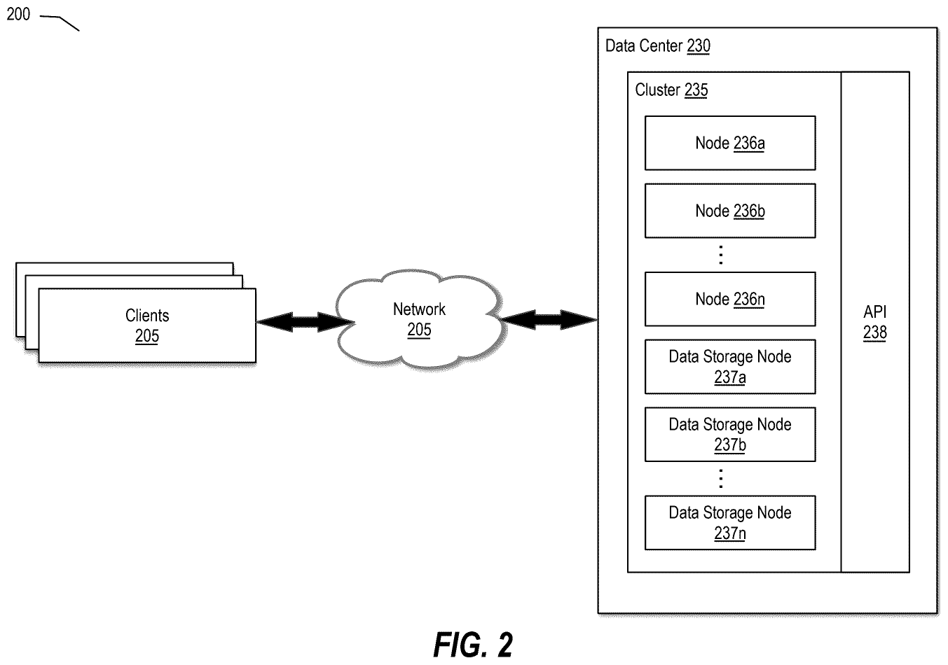

FIG. 2 is a block diagram illustrating an example on-premise environment 200 in which various embodiments may be implemented. In the context of the present example, the environment 200 includes a data center 230, a network 205, and clients 205 (which may be analogous to clients 105). The data center 230 and the clients 205 may be coupled in communication via the network 205, which, depending upon the particular implementation, may be a Local Area Network (LAN), a Wide Area Network (WAN), or the Internet. Alternatively, some portion of clients 205 may be present within the data center 230.

The data center 230 may represent an enterprise data center (e.g., an on-premises customer data center) that is build, owned, and operated by a company or the data center 230 may be managed by a third party (or a managed service provider) on behalf of the company, which may lease the equipment and infrastructure. Alternatively, the data center 230 may represent a colocation data center in which a company rents space of a facility owned by others and located off the company premises. The data center 230 is shown including a distributed storage system (e.g., cluster 235). Those of ordinary skill in the art will appreciate additional information technology (IT) infrastructure would typically be part of the data center 230; however, discussion of such additional IT infrastructure is unnecessary to the understanding of the various embodiments described herein.

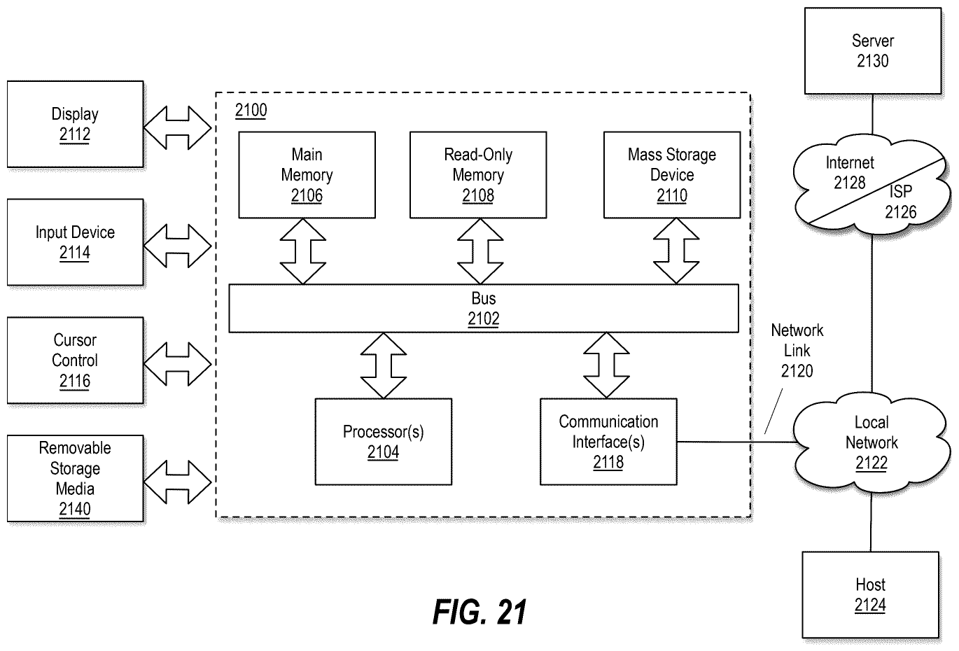

Turning now to the cluster 235 (which may be analogous to cluster 101), it includes multiple nodes 236a-n and data storage nodes 237a-n (which may be analogous to nodes 102 and which may be collectively referred to simply as nodes) and an Application Programming Interface (API) 138. In the context of the present example, the nodes are organized as a cluster and provide a distributed storage architecture to service storage requests issued by one or more clients (e.g., clients 205) of the cluster. The data served by the nodes may be distributed across multiple storage units embodied as persistent storage devices, including but not limited to hard disk drives, solid state drives, flash memory systems, or other storage devices including storage class memory. A non-limiting example of a node is described in further detail below with reference to FIGS. 19 and 21.

The API 238 may provide an interface through which the cluster 235 is configured and/or queried by external actors. Depending upon the particular implementation, the API 138 may represent a Representational State Transfer (REST)ful API that uses Hypertext Transfer Protocol (HTTP) methods (e.g., GET, POST, PATCH, DELETE, and OPTIONS) to indicate its actions. Depending upon the particular embodiment, the API 238 may provide access to various telemetry data (e.g., performance, configuration and other system data) relating to the cluster 235 or components thereof. As those skilled in the art will appreciate various types of telemetry data may be made available via the API 137, including, but not limited to measures of latency, utilization, and/or performance at various levels (e.g., the cluster level, the node level, or the node component level).

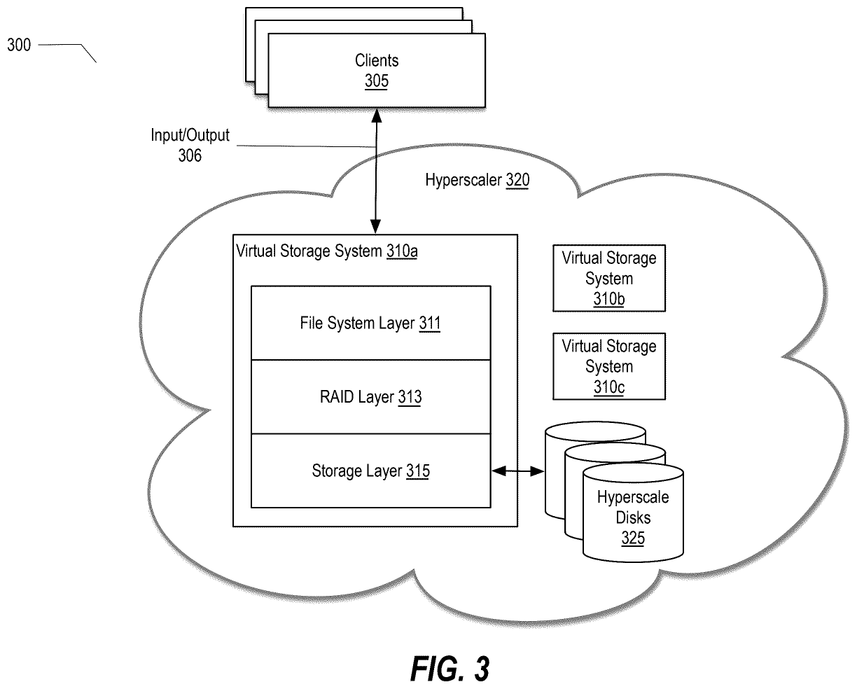

FIG. 3 is a block diagram illustrating an example cloud environment (e.g., hyperscaler 320) in which various embodiments may be implemented. In the context of the present example, a virtual storage system 310a, which may be considered exemplary of virtual storage systems 310b-c (which may collectively operate as cluster representing a distributed storage system or a storage cluster), may be run (e.g., on a VM or as a containerized instance, as the case may be) within a public cloud provided by a public cloud provider (e.g., hyperscaler 320). In this example, the virtual storage system 310a makes use of storage (e.g., hyperscale disks 325) provided by the hyperscaler, for example, in the form of solid-state drive (SSD) backed or hard-disk drive (HDD) backed disks. The cloud disks (which may also be referred to herein as cloud volumes, storage devices, or simply volumes or storage) may include persistent storage (e.g., disks) and/or ephemeral storage (e.g., disks), which may be analogous to physical storage 108.

The virtual storage system 310a may present storage over a network to clients 305 (which may be analogous to clients 105 and 205) using various protocols (e.g., small computer system interface (SCSI), Internet small computer system interface (ISCSI), fibre channel (FC), common Internet file system (CIFS), network file system (NFS), hypertext transfer protocol (HTTP), one or more object protocols, web-based distributed authoring and versioning (WebDAV), or a custom protocol. Clients 305 may request services of the virtual storage system 310 by issuing Input/Output requests 306 (e.g., file system protocol messages (in the form of packets) over the network). A representative client of clients 305 may comprise an application, such as a database application, executing on a computer that “connects” to the virtual storage system 310 over a computer network, such as a point-to-point link, a shared local area network (LAN), a wide area network (WAN), or a virtual private network (VPN) implemented over a public network, such as the Internet.

In the context of the present example, the virtual storage system 310a is shown including a number of layers, including a file system layer 311 and one or more intermediate storage layers (e.g., a RAID layer 313 and a storage layer 315). These layers may represent components of data management software or storage operating system (not shown) of the virtual storage system 310. The file system layer 311 generally defines the basic interfaces and data structures in support of file system operations (e.g., initialization, mounting, unmounting, creating files, creating directories, opening files, writing to files, and reading from files). A non-limiting example of the file system layer 311 is the Write Anywhere File Layout (WAFL) Copy-on-Write file system (which represents a component or layer of ONTAP software available from NetApp, Inc. of San Jose, CA).

The RAID layer 313 may be responsible for encapsulating data storage virtualization technology for combining multiple hyperscale disks 325 into RAID groups, for example, for purposes of data redundancy, performance improvement, or both. The storage layer 315 may include storage drivers for interacting with the various types of hyperscale disks 325 supported by the hyperscaler 320. Depending upon the particular implementation the file system layer 311 may persist data to the hyperscale disks 325 using one or both of the RAID layer 313 and the storage layer 315.

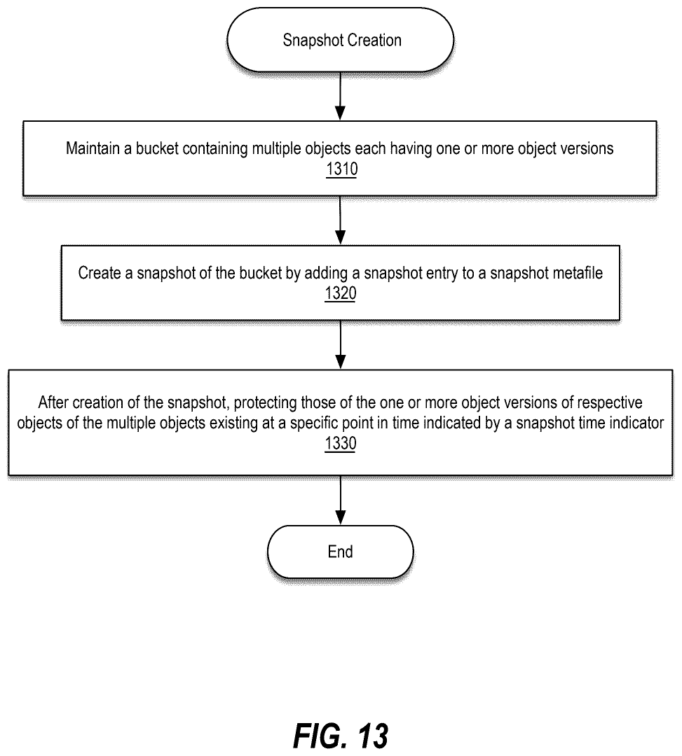

The various layers, functional units, and modules described herein, and the processing described below, for example, with reference to the flow diagrams of FIGS. 13-14 and 16-17 may be implemented in the form of executable instructions stored on a machine readable medium and executed by one or more processing resources (e.g., one or more microcontrollers, one or more microprocessors, one or more central processing unit cores, one or more application-specific integrated circuits (ASICs), one or more field programmable gate arrays (FPGAs), and the like and/or various combinations thereof) and/or in the form of other types of electronic circuitry. For example, the processing may be performed by one or more virtual or physical computer systems of various forms (e.g., servers, blades, network storage systems or appliances, and storage arrays, such as the computer system described with reference to FIG. 21 below.

### Example Multitiered Namespace

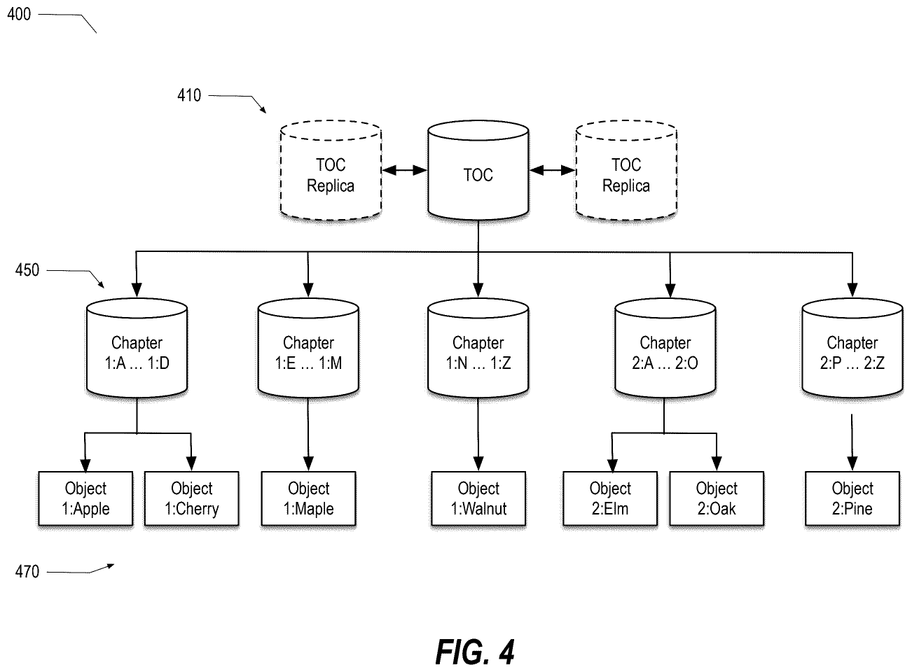

FIG. 4 illustrates an example multitiered namespace 400 built from a changing collection of small variable length databases in accordance with one embodiment. In the context of the present example, a top tier 410 of the namespace 400 is a single database called the Table of Contents (TOC), and each record in it points to a second-tier 450 having child databases called chapter databases. Each chapter database may be responsible for holding all names within a contiguous range of the namespace—so, one chapter might have names that start with A through F, while the next chapter has all names that start with G through H, and so on.

In one embodiment, a storage OS (operating system) of a distributed storage system (e.g., cluster 101, cluster 235, or a cluster including virtual storage systems 310a-c) provides a mechanism that scales with a flexgroup that may contain up to 400 billion objects in a single bucket if needed. A flexgroup is conceptually a single group that can have a large number of volumes on various aggregates (e.g., sets of persistent storage devices or disks) of various storage nodes. A large number of buckets can be located in a flexgroup. The storage OS may utilize multiple nodes and volumes in order to avoid a single volume bottleneck. In one example, objects are accessed exclusively through an object storage protocol (OSP) protocol (e.g., the Amazon S3 protocol, not Network attached storage (NAS) protocols (e.g., Network File System (NFS) protocol, Common Internet File System (CIFS) protocol, and the like). Clients (e.g., clients 105, 205, or 305) may use the OSP to create objects within a bucket, which may refer to a discrete container that stores a collection of objects, of the distributed storage system. Each such object is given a name, and the collective bucket is expected to be able to later retrieve an object by that name efficiently. Further, clients expect to be able to iterate the list of named objects at any time—starting at any name—and receive subsequent names in alphabetic sort order.

A flexgroup can hold many separate buckets. Despite each bucket having its own namespace from the client or end user's point of view, the parent flexgroup may have a single table of contents (TOC) database that covers all buckets stored in the flexgroup. This works because the bucket number may be included as part of the sort key for an object name, and each bucket may use its own distinct collection of chapter databases underneath for that common TOC. So, in one embodiment, not only do bucket 1's names all sort before bucket 2's names, those two buckets have entirely disjoint collections of chapter databases—meaning that any given chapter database holds object names for exactly one bucket. Each bucket may start with one chapter database when it's empty, but over time it might grow to include more chapter databases.

The collection of chapter databases used by a bucket changes over time. If the client has been doing lots of PUTs and a chapter database has grown too large, the chapter database divides itself into two databases right around its midline and updates the TOC to reflect the new responsibilities. Alternatively, if a chapter database gets too small, it merges with one of its siblings and again updates the TOC. That sort of behavior is similar to use of B+ trees—but there's only one level involved here, since the TOC itself may not divide.

The TOC may be stored at a fixed file identifier (ID), and the TOC can be replicated among multiple (e.g., three) different flexgroup members for resiliency. A special protocol may be used to help all members know where copies of the TOC are located. For example, the TOC itself may be slow-changing: its records may only change when whole chapter databases are inserted and removed. This makes the TOC a great candidate for read-only caching. Having that sort of high-level sorting data cacheable means that the storage OS can now make reasonable routing decisions to find a correct chapter for an object. If the flexgroup heuristics have been doing well, then once the correct chapter is located, it will be determined that most of the objects mentioned by that chapter are on the same member volume. Thus, scaling, namespace distribution, caching, automatic corruption recovery, and even built-in redundancy for the critical parts of the namespace may be supported.

For the lower tier 450, each bucket may have its own discrete set of chapters. Each chapter covers a contiguous range of the namespace. Chapter records of a chapter may point to individual objects 470 with that bucket. Each object may be stored as a file system index node (inode). Some object metadata may be stored with the inode, some in inode labels, and/or some in the chapter records.

### Example Without Object Versioning

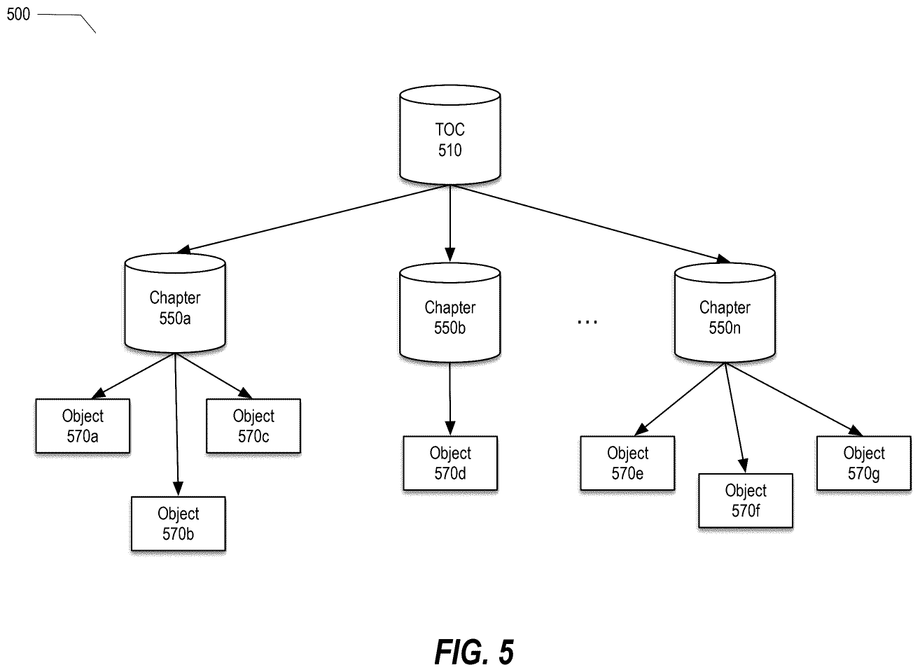

FIG. 5 illustrates a tree 500 of objects (e.g., objects 570a-g) without object versioning. In this example, TOC 510 may be analogous to the TOC maintained in layer 410 of FIG. 4 and chapters 550a-n may be analogous to the chapter databases maintained in layer 450 of FIG. 4. In this example, an unversioned bucket includes objects that are assumed to only include a single version of each object. As such, the growth of a given chapter, which includes chapter records (not shown) having object records (not shown) for each object is linear as a function of the number of objects.

As described further below, in some examples, an unversioned bucket may maintain one or more “hidden” or “internal” versions of objects corresponding to those deleted explicitly or implicitly by a lifecycle policy or a client. According to one embodiment, unversioned buckets may internally use the versioning infrastructure utilized by versioned buckets to keep track of objects that have been deleted but are part of a previous snapshot, even though such non-current versions are not visible to external bucket users. These unversioned buckets may be marked “internally versioned” so that they can be presented to clients as unversioned.

### Example of a Naïve Approach to Object Versioning

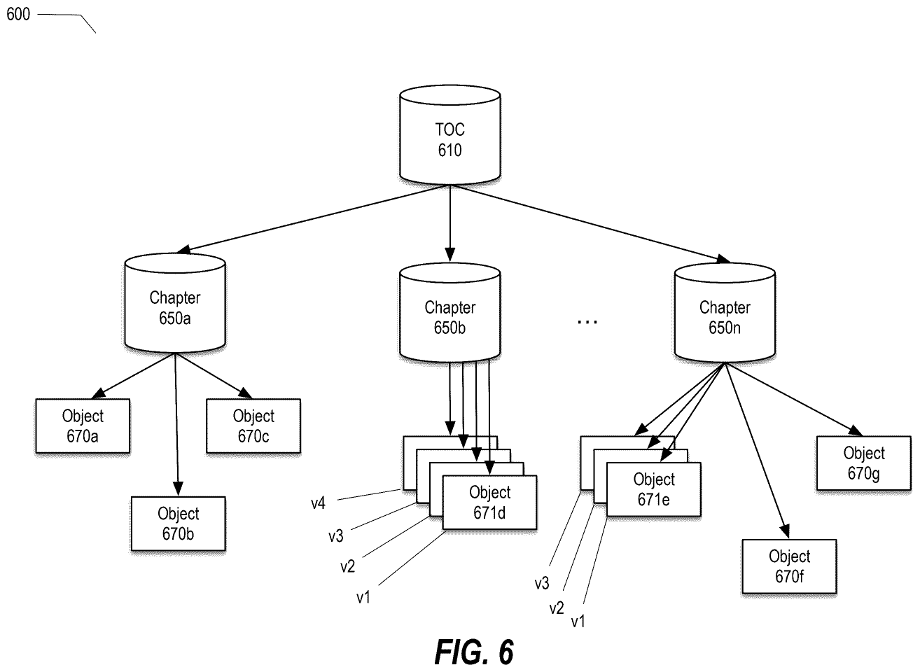

FIG. 6 illustrates one approach for representing object versions within a V+ tree by including a version ID in chapter object records. In this example, in which TOC 610 may be analogous to TOC 510 and chapter databases 650a-n may be analogous to chapter databases 550a-n, the bucket in which objects (e.g., objects 670a-c, 670f-g, 671d, and 671e) are stored is a versioned bucket. As such, each object may include multiple versions. For example, when an object is overwritten, instead of deleting a predecessor object (i.e, an object having the same name), the new object becomes current and the prior object is retained as a prior version. For example, object 671d is shown including a current version (v4) and multiple prior versions v3, v2, and v1. Similarly, object 671e is shown including a current version (v3) and multiple prior versions v2 and v1. As shown by the arrows originating from chapter database 650b and terminating at versions v1, v2, v3, and v4 of object 671d and the arrows originating from chapter database 650n and terminating at versions v1, v2, and v3 of object 671e, in this naïve implementation, a chapter record including an object record for each object would add additional data (e.g., a version ID, a pointer to the corresponding object version, and potentially other data and/or metadata) for each object version. Such an approach to object versioning has a number of disadvantages, including complicating object enumeration, expanding the size of chapter records, and increasing search depth.

### Example of an Improved Approach to Object Versioning

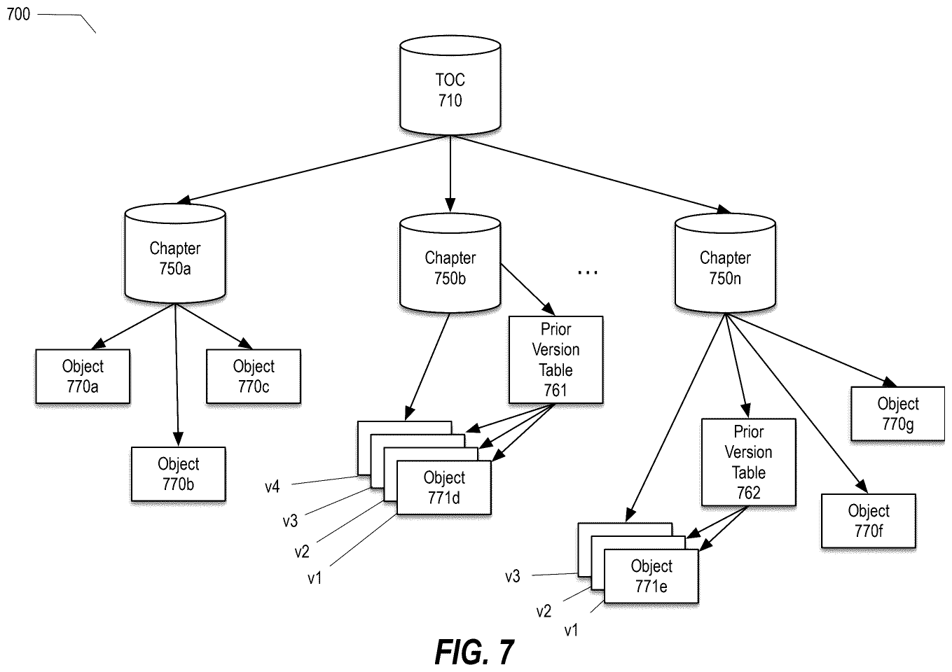

FIG. 7 illustrates an example approach for representing object versions within a V+ tree 700 in accordance with one or more embodiments. According to one embodiment, V+ tree 700 may be maintained on persistent storage (e.g., physical storage 108) and some portion of V+ tree 700 may be cached within a memory of a node (e.g., one of nodes 102) to facilitate fast access. In this example, in which TOC 710 may be analogous to TOC 510 and chapter databases 750a-n may be analogous to chapter databases 550a-n, the bucket in which objects (e.g., objects 770a-c, 770f-g, 771d, and 771e) are stored is a versioned bucket.

In contrast to the naïve approach depicted in FIG. 6, in which a chapter grows linearly based on the average number of versions per object associated with the chapter database, a prior version table (e.g., prior version table 761 and prior version table 762) is logically interposed between the chapter database and the various prior versions of a particular object. In this manner, the chapter record of a chapter database continues to grow linearly based on the number of objects as only a constant number of additional data items (e.g., a pointer to the prior version table) are added to the chapter record for each object having multiple versions.

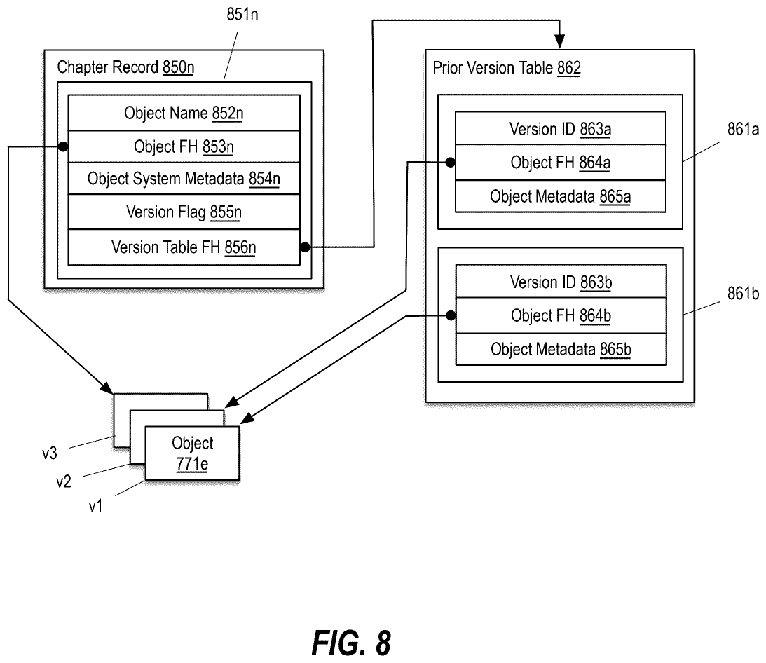

As described further below with reference to FIG. 8, in one embodiment, the object records for each object having multiple versions within a chapter database may always point to the current version of an object having multiple versions, thereby facilitating more efficient object enumeration as the chapter record is not encumbered with excessive data/metadata relating to all object versions of all objects within the chapter database. Additionally, object versioning may be supported with the inclusion of minimal data (e.g., a pointer to the prior version table for the particular object), thereby avoiding excessive expansion of the size of the chapter records within additional data/metadata relating to each version of each object. Non-limiting examples of a chapter record, object records, a prior version table, and prior version table records are described further below with reference to FIG. 8.

FIG. 8 is a block diagram illustrating an example chapter record 850n and an example prior version table 862 in accordance with one or more embodiments. In the context of the present example, an object record structure (e.g., object record 851n) that may be used for objects having multiple versions is shown within chapter record 850n. Object record 850n corresponds to object 771e. While for simplicity, only a single chapter record is shown, it is to be appreciated for each additional object (e.g., objects 770g and 770f) within the chapter database at issue (e.g., chapter database 750n) an object record similar to object record 851n as well as a corresponding prior version table (having a structure similar to prior version table 862) may be added to the chapter record 850n.

In the context of the present example, chapter record 850n is shown including an object record 851n for object 771e. Object record 851n includes an object name 852n, an object file handle (FH) 853n, other object system metadata 854n, a version flag 855n, and a version table FH 856n. The object name 852n may be a variable-length string representing the name of object 771e. The object FH 853n may represent an index node (e.g., an inode) of a file system object (e.g., a file) in which the data for the current version (e.g., v3 in this example) of object 771e is stored. The version flag 855n may be used to distinguish between objects initially created after versioning was enabled for the bucket and hence having a version ID and objects initially created prior to versioning having been enabled for the bucket and hence having no version ID or a version ID of null.

In the context of the present example, prior version table 862 is shown including a prior version table record (e.g., prior version table records 861a-b) for each prior version (e.g., v1 and v2) of object 771e. Each version table record includes a version ID (e.g., version ID 863a-b), an object FH 864a-b, and object metadata (e.g., object metadata 865a-b). The version ID may be used as the key for the prior version table 862 and may represent the time at which the particular version of the object was created (e.g., including seconds and nanoseconds). In this manner, when versions of an object are listed, they will appear in the order in which they were created with the most recently stored version (the current version) returned first. The object FH may represent an index node (e.g., an inode) of a file system object (e.g., a file) in which the data for the particular version (identified by the version ID) of object 771e is stored. For example, object FH 863a points to v2 of object 771e and object FH 863b points to v1 of object 771e. Objects (e.g., object 771e) may include data and metadata. The metadata may include a bucket number of the bucket in which the object resides, the object name, and a checksum or message digest (e.g., MD5) of the data.

According to one embodiment, when a client (e.g., one of clients 105, 205, or 305) requests the data for a particular object, for example, by issuing a read request to the file system (e.g., file system layer 311) of a node (e.g., one of nodes 102) for the particular object (e.g., identified by its object name), the file system will locate the appropriate chapter record (e.g., within the appropriate chapter database) and locate the particular object within the chapter record using the object name as the key. Then, assuming the request is for the data for the current version of the particular object, the file system, will retrieve the data using the object FH of the object. Otherwise, if the request is for the data of a prior version, then the prior version table may be searched using the supplied version ID as the key to locate the prior version table record for the prior version at issue and the object FH of the prior version table record may be used to retrieve the data. In either case, the retrieved data may then be returned to the client.

According to one embodiment, when the client overwrites the data for a particular object that already exists, for example, by issuing a write request (e.g., a PUT request) to the file system for the particular object, the file system will locate the appropriate chapter record. Then, the file system, locates the particular object within the chapter record using the object name as the key. As the object already exists, a new version of the object is created within the V+ tree by adding a new prior version record to the prior version table and updating the object FH of the object record to point to the new version (which now represents the current version of the object).

### Brief Overview of Example Snapshot Operations

In various examples described herein, snapshots may be created, listed, browsed, restored, and deleted. Creation of a snapshot involves capturing or protecting the current version of respective objects and multipart objects that exist in a current namespace defined by a bucket (e.g., including multiple chapters containing alphabetically contiguous segments of the namespace) as of a creation time associated with the snapshot. As described further below, the storage system maintains information (e.g., a snapshot name and a snapshot creation time) for all existing snapshots of each bucket.

Listing snapshots allows a storage administrator to view all existing snapshots for a given bucket. The listing of snapshots may present, among other information, the snapshot name and the creation time for each snapshot of the given bucket.

Browsing a snapshot allows a storage administrator to view the content of a snapshot, for example, presented as a synthetic bucket (or snapshot “pseudo-bucket”). This allows the storage administrator to view the objects protected by a snapshot without having to first restore the snapshot.

Restoring a snapshot essentially returns the state of a bucket to a prior state, albeit, without object history that may have existed as of the creation time associated with the snapshot being restored. Depending on the particular implementation, an object may be restored by either cloning it to create a new current version on top of all of the existing versions, or by promoting the previous version to be the current version, for example, by deleting one or more current versions until the correct previous version represents the current version. As illustrated by various examples provided herein, in the latter case, all versions with a starting time indication newer than the snapshot being restored may be deleted. Similarly, prior versions may be tracked and may be made visible to clients as needed based on their respective time indicators. The storage system may also clear out any tracking of partially-completed objects or object parts or otherwise dispose of partially-completed objects or object parts. This may be performed for individual objects, or all at once at the bucket level for a bucket-level restore. Various examples and scenarios are provided below to illustrate expected behavior of a snapshot restore operation.

Snapshot deletion removes the deleted snapshot from the list of existing snapshots for the bucket at issue. Additionally, snapshot deletion may involve permanently deleting any hidden or internal object versions. Since hidden or internal object versions may be protected by multiple snapshots, for each version of each object, a given hidden or internal version should not be permanently deleted until the last snapshot protecting the given hidden or internal version has been deleted. Alternatively, rather than evaluating hidden or internal versions as part of snapshot delete processing, a bucket lifecycle policy, which automatically iterates the object versions periodically, may be used to check for expired versions. While the lifecycle policy is iterating object versions, it may check hidden or internal versions for possible permanent deletion. If no snapshot exists with a time indicator before the deletion time indicator, allow for permanent deletion.

### Bucket-Level Snapshot Overview

A server-implemented bucket-level snapshot (e.g., a snapshot of a bucket), consistent with embodiments described herein, captures a set of object versions in a given bucket. The storage system may keep track of a time indicator (e.g., a create or creation time) in the form of a timestamp or an epoch corresponding to the time of snapshot creation such that any object version existing as of the creation time is protected from deletion. As described further below, in one embodiment, only the version history existing at the time of backup is kept rather than all versions older than the time of backup.

Because the storage system also maintains time indicators (e.g., timestamps and/or epochs) from the time of creation of every version of an object, a point-in-time snapshot may be defined as an actual timestamp or epoch from which the storage system may determine the corresponding object versions. Thus, in examples described herein, creation of a timestamp snapshot includes the recording of a creation timestamp and an epoch snapshot includes the recording of a creation epoch. As noted above, as used herein, the general term “snapshot” is intended to refer to a timestamp snapshot or an epoch snapshot unless the context limits such reference to one or the other.

A timestamp snapshot enables a storage system to retroactively define a snapshot. For example, the storage system may generate a snapshot for a timestamp in the past (e.g., 5 minutes ago, a day ago, etc.). For a retroactive snapshot requested too far in the past in which some of the relevant object versions have been deleted during an unprotected period, a partial snapshot may be produced using content still in place when the protection from deletion is added.

In accordance with one embodiment of the present disclosure, an epoch snapshot may be used. As used herein, an epoch may represent a monotonically increasing number that is incremented to mark the passage of time whenever a significant event occurs. An epoch snapshot includes the recording of a current epoch at the time of creation of the epoch snapshot. When making use of epoch snapshots, each bucket may maintain a monotonically increasing epoch, which may be kept consistent across a storage cluster using infrastructure layer resources, such as Remote Access Layer (RAL) resources, which coordinate caching and transactional updates of information across the storage cluster. This bucket epoch may act like a snapshot ID without the space/storage limitations that come with a snapshot ID. In accordance with one embodiment of the present disclosure, the storage server records epochs as metadata. An epoch may be an abstracted form of a timestamp. For example, each bucket may maintain a monotonically increasing epoch which may be kept consistent across a storage cluster. This bucket epoch may be configured to behave like a snapshot ID, but is not limited to storage service-imposed size limitation. In one embodiment, during the creation of a manual or scheduled snapshot, the snapshot ID (or name) and timestamp may be associated with the bucket's current epoch, and then the epoch is incremented. In one embodiment, the bucket epoch is not stamped on the object or object part until it is complete, thus pending creations are not included in the snapshot.

Whenever an object is finalized by adding the object to a namespace, the storage system may record the current bucket epoch as its starting epoch. When the object is deleted, or when an object version is removed via a lifecycle policy, the storage system may record the current bucket epoch “minus 1” as its ending epoch. This provides a range of epochs, corresponding to a period of real-world time, during which that object is protected by snapshots taken at those epochs. As long as those snapshots exist (e.g., are not deleted, either explicitly or by restoring an older snapshot), the object may be kept in an internal storage system database, such as a Prior Version Table (PVT), as a hidden version. This ensures its availability if it is needed in connection with a restore operation.

As those skilled in the art will appreciate, the use of an epoch allows for the synchronization of events in a distributed system without introducing inaccuracies. An epoch may be more consistent and precise than a timestamp, as a storage system may need to compensate for time changes or cross-cluster inconsistencies but does not need to do the same for an epoch. Furthermore, the storage system retains control of an epoch number that is decoupled from clock or wall time and can update the epoch number precisely and synchronously at its choosing. Additionally, those skilled in the art will appreciate that various potential time skew scenarios (e.g., when the system time of a given node goes backward or the time between nodes becomes out of synch) may be easily addressed by, for example, by imposing a constraint that the creation time of a new object should always be larger than the latest snapshot creation time.

In one embodiment, a snapshot logically protects some or all of the following items (e.g., by ensuring that these items are not deleted or modified):
Object inodes for objects whose time indicator range (e.g., creation time to delete-time range) encompasses the time indicator of the snapshot. This may include previous object versions.
System metadata that is stored in the inode for objects and previous versions captured in the snapshot. This metadata may be obtained from the inode.
Inode labels (e.g., for tags and metadata) for the inodes corresponding to objects and previous versions captured in the snapshot (e.g., by ensuring these labels are not deleted).

In one embodiment, the snapshot does not protect some or any the following:
Older versions of chapter databases, PVT databases, and Table of Contents. The current chapter database and the PVTs may include entries for all objects, including those captured in previous snapshots and subsequently deleted. Thus, the chapter databases and PVT databases may include the combined lookup information for all snapshots and may not be part of an individual snapshot. When a snapshot is browsed or restored, the server may reconstruct the information needed from the latest chapter databases and PVTs. There may be a single Table of Contents, which is the top-level index that informs which chapter to look in for a given object name.
A Pending Creation Table (PCT), which may be used to keep track of objects currently being constructed and not yet finalized in the object namespace. Pending creations may be outside the scope of a snapshot.
A Multipart Upload Table (MUT), which may be used to keep track of multipart objects in which the client has provided some or all parts but has not issued the completion operation yet. As such, not-yet-completed multipart objects are also not part of a snapshot even though some of their parts may have been completely uploaded at the time of the snapshot.

### Example Snapshot Creation for an Unversioned Bucket

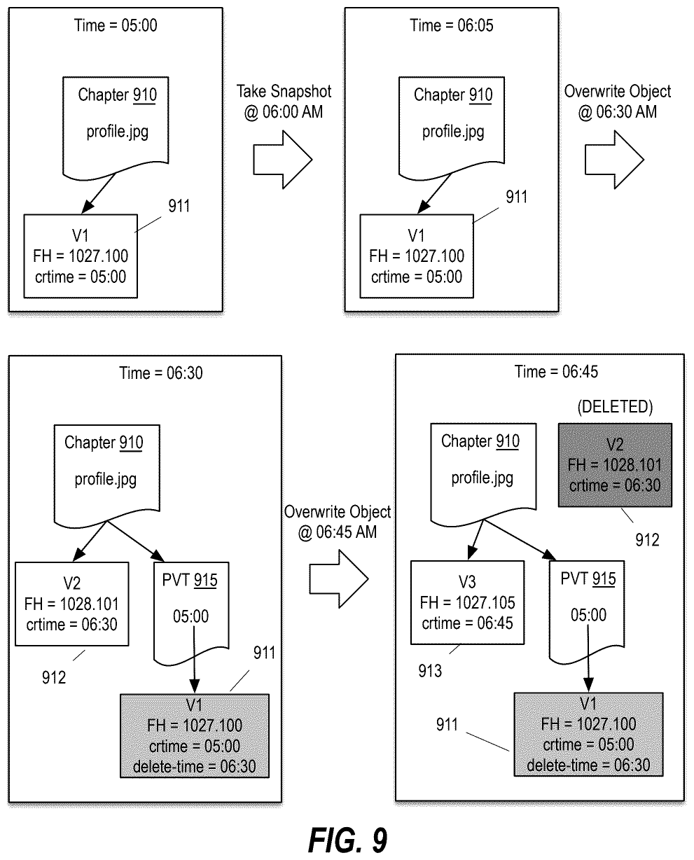

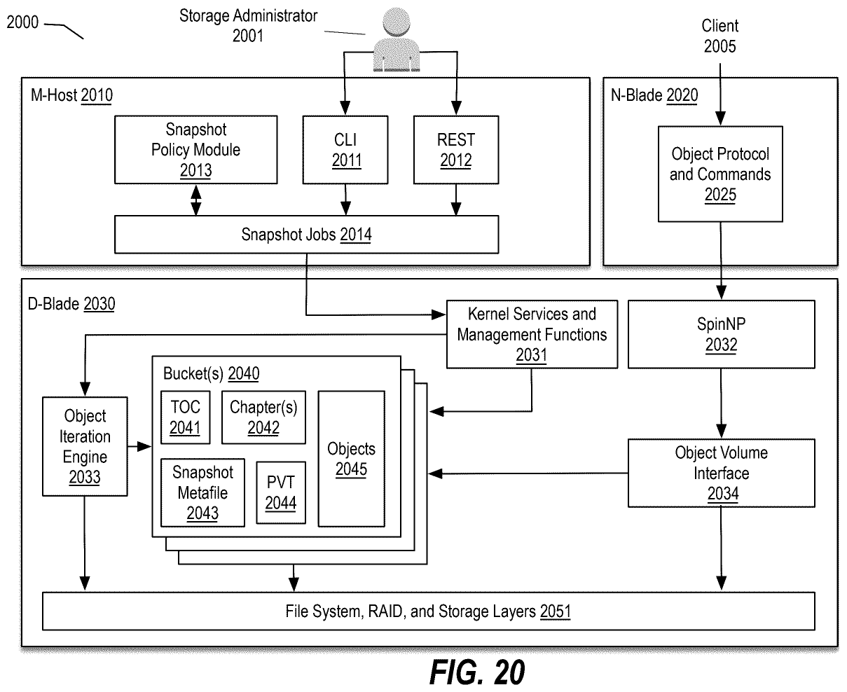

FIG. 9 is a block diagram illustrating an example scenario involving creation of a snapshot of an unversioned bucket (e.g., one of buckets 2040 of FIG. 20) and the impact of subsequent object overwrites in accordance with one or more embodiments. In the context of the present example, object versions having a white background are visible to a client of the storage system, object versions having a dark gray background no longer exist (are permanently deleted), and object versions having a light gray background are hidden or internal versions that are maintained by the storage system on behalf of the client.

As described further below, maintaining hidden or internal versions provides a number of advantages, including facilitating the performance of a “roll back” restore, for example, as a series of explicit deletions until the storage system gets to the desired object version representing the correct new current version based on a time indicator (e.g., a creation time) associated with the snapshot being restored and one or more time indicators (e.g., a creation time and a deletion time) associated with the object version at issue. As a result, embodiments described herein, facilitate promotion of a previously hidden object version that has been maintained internally and that is not currently visible to the client to the current new version of an object being restored. As noted above, this is a feature that is not and cannot be supported by existing third-party tools as they do not offer protection on behalf of a client and therefore object versions that have been deleted by a client cannot be recovered. Another advantage of maintaining hidden or internal versions is the ability to provide support for snapshot browsing, in which the client can view the contents of a snapshot by sending read-only requests to a specially-named synthetic bucket. This allows the client to access the contents of the snapshot without forcing the client to first perform a restore.

In this present example, at time 05:00 an object named “profile.jpg” is created within a chapter 910, which may be analogous to one of chapters 750a-n. As such, a current version (V1 911) of the object, having a creation time (crtime) of 05:00 is shown being pointed to by the chapter 910 (which may be analogous to one of chapters 550a-n).

At 06:00 AM, a snapshot (not shown) is taken of the bucket (not shown) in which the object resides and no other changes of significance occur with respect to the object. As such, at time 06:05, object version V1 911 remains the current version.

At 06:30 AM, the object is overwritten and no other changes of significance occur with respect to the object. As such, at time 06:30, object version V2 912, having a creation time of 06:30, now represents the current version of the object. Additionally, a prior version table (PVT) 915 (which may be analogous to PVT 761, 762, or 862) has been created for the object to maintain information regarding prior versions and is shown pointing to prior object version V1 911, which is now a hidden or internal version (as this is an unversioned bucket in which only the current version of a given object should be visible to a client).

At 06:45 AM, the object is again overwritten and no other changes of significance occur with respect to the object. As such, at time 06:45, object version V3 913, having a creation time of 06:45, now represents the current version of the object. Additionally, prior object version V1 911 remains as a hidden or internal version (as it is protected by the snapshot of the bucket created at 06:00 AM) and prior object version V2 912 is permanently deleted (as any restore in the context of an unversioned bucket should only roll back to the most recent prior version of the object that is protected by a snapshot, which in this case is prior object version V1 911).

### Example Snapshot Creation for a Versioned Bucket

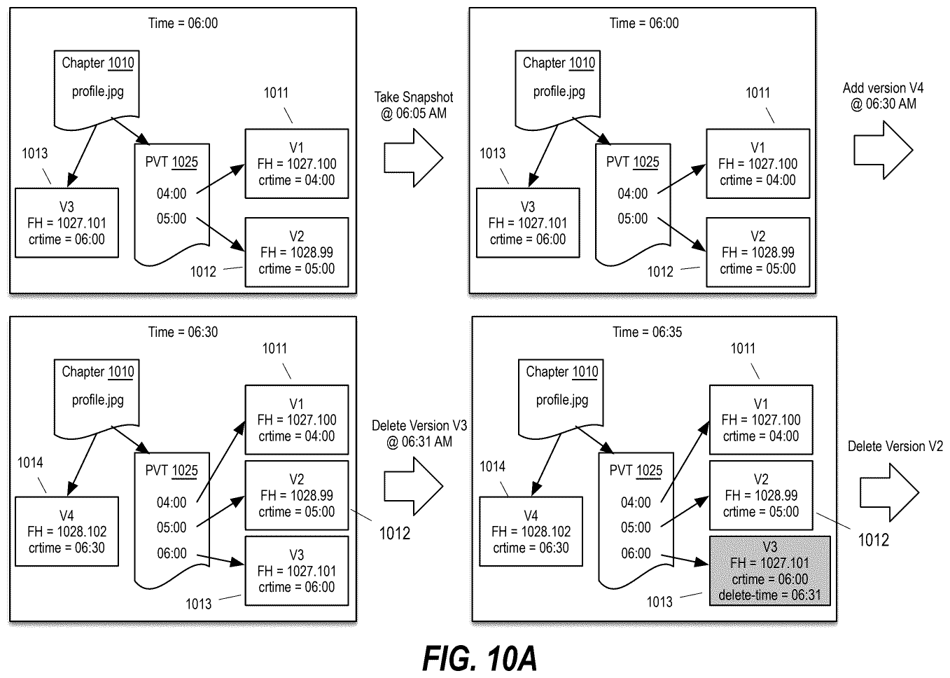

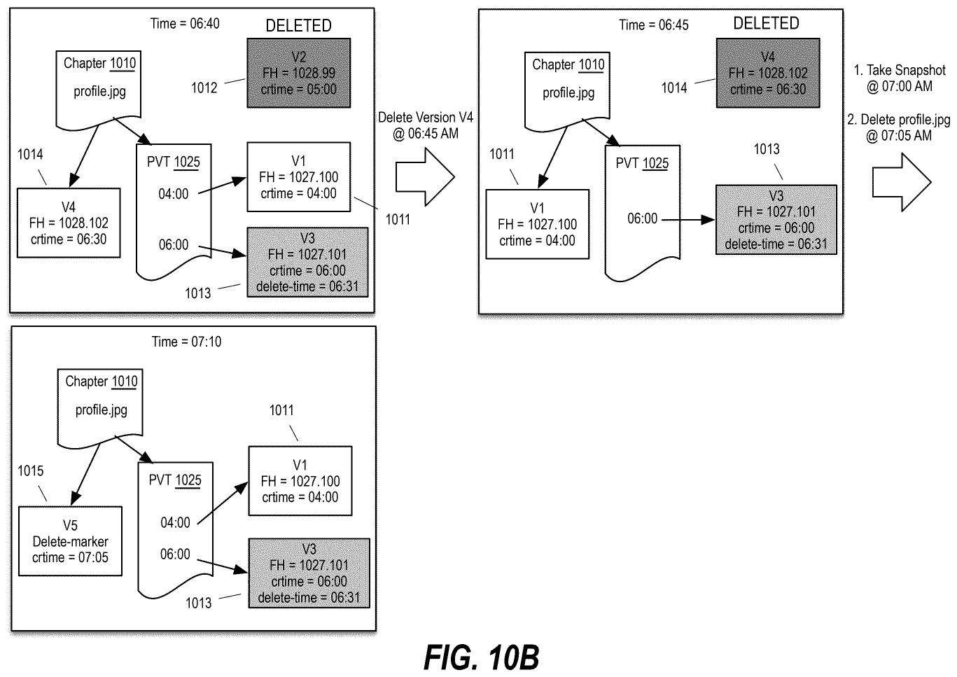

FIGS. 10A-10B are block diagrams illustrating an example scenario involving creation of snapshots of a versioned bucket (e.g., one of buckets 2040 of FIG. 20) and the impact of subsequent deletion of various object versions in accordance with one or more embodiments. As above, in the context of the present example, object versions having a white background are visible to a client of the storage system, object versions having a dark gray background no longer exist (are permanently deleted), and object versions having a light gray background are hidden or internal versions that are maintained by the storage system on behalf of the client to facilitate, among other things, performance of a “roll back” restore.

In this present example, at time 06:00 an object named “profile.jpg” has three versions (i.e., a current version V3 1013 and two prior versions V1 1011 and V2 1012) associated with a chapter 1010, which may be analogous to one of chapters 750a-n. As such, a PVT 1025 (which may be analogous to PVT 761, 762, or 862) is shown logically interposed between the chapter 1010 and the prior versions. In contrast to the example of FIG. 9, in this example, the prior versions are not hidden or internal versions at present as they have not been explicitly or implicitly deleted.

At time 06:05 AM, a snapshot (not shown) is taken of the bucket (not shown) in which the object resides and no other changes of significance occur with respect to the object. As such, at time 06:05, the state of the bucket generally remains the same as at time 06:00. Notably, in this example, it is assumed a snapshot only protects the current version (i.e., version V3 1013 of the object) and not the object history. Therefore, prior versions V1 1011 and V2 1012 are not protected by this snapshot, thereby allowing either or both of these prior versions to be freely deleted by the client.

At time 06:30 AM, version V4 1014 of the object is added (having a crtime of 06:30) resulting in version V4 1014 becoming the current version and version V3 1013 becoming a prior version to which the PVT 1025 points.

At time 06:31, version V3 1013 of the object is deleted. Since version V3 1013 is protected by the existing snapshot taken at 06:05 AM (that is, version V3 1013 was the current version—had the latest creation time among all existing client-visible versions of the object—as of the creation time of the existing snapshot), version V3 1013 is not permanently deleted. Rather, version V3 1013 is marked with a deletion indicator (e.g., by adding a delete time of 06:31) and version V3 1013 becomes a hidden or internal version that is no longer visible to the client. It is to be noted that version V3 1013 existed within the bucket during a timeframe of 06:00 to 06:31 defined by its crtime and its delete-time. This allows a determination to be later made, if and when necessary, for example, during a subsequent restore of the existing snapshot taken at 06:05 AM that version V3 1013 was the current version of the object at the creation time associated with the snapshot and represents the correct version to be restored as the new current version (despite it being a hidden or internal version that is no longer presented to the client during object enumeration or other bucket operations).

At some time at or after 06:35 AM and before or at 6:40 AM, version V2 1012 of the object is deleted, resulting in version V2 1012 being permanently deleted because, in this case, prior version V2 1012 is not protected by the existing snapshot taken at 06:05 AM as prior version V2 1012 was not the current version of the object as of the creation time of the existing snapshot.

At time 06:45 AM, version V4 1014 (the current version of the object) is deleted, resulting in version V4 1014 being permanently deleted and the most recent prior version that is not a hidden or internal version (in this case, prior version V1 1011) becoming the new current version. Notably, version V4 1014 is permanently deleted because, as in the case of version V2 1012, version V4 is not protected by the existing snapshot taken at 06:05 AM as version V4 1014 did not exist as of the creation time of the existing snapshot and therefore could not have been the current version at that time.

At time 07:00 AM another snapshot is taken of the bucket and at time 07:05 AM the object “profile.jpg” is deleted. In this example, this results in a new current version V5 1015 of the object being created with a crtime of 07:05 and having a delete marker. This illustrates the difference between a specific version deletion (where the client specifies the version ID) and a regular deletion (where the client just requests a delete against an object without specifying a version ID). In a versioned bucket, a regular deletion does not hide or delete any existing versions, it actually creates an entirely new version of a special kind of object version called a “delete marker,” which is a different concept from the earlier described use of a “deletion indicator.” As those skilled in the art will appreciate, delete markers are client visible in a special way. Objects whose current version is a delete marker will not show in a regular object enumeration (e.g., ListObjects/ListObjectsV2), but they can be seen when listing versions (e.g., ListObjectVersions). Additionally, the client can perform certain interactions with delete markers, such as explicitly deleting them (using their version ID).

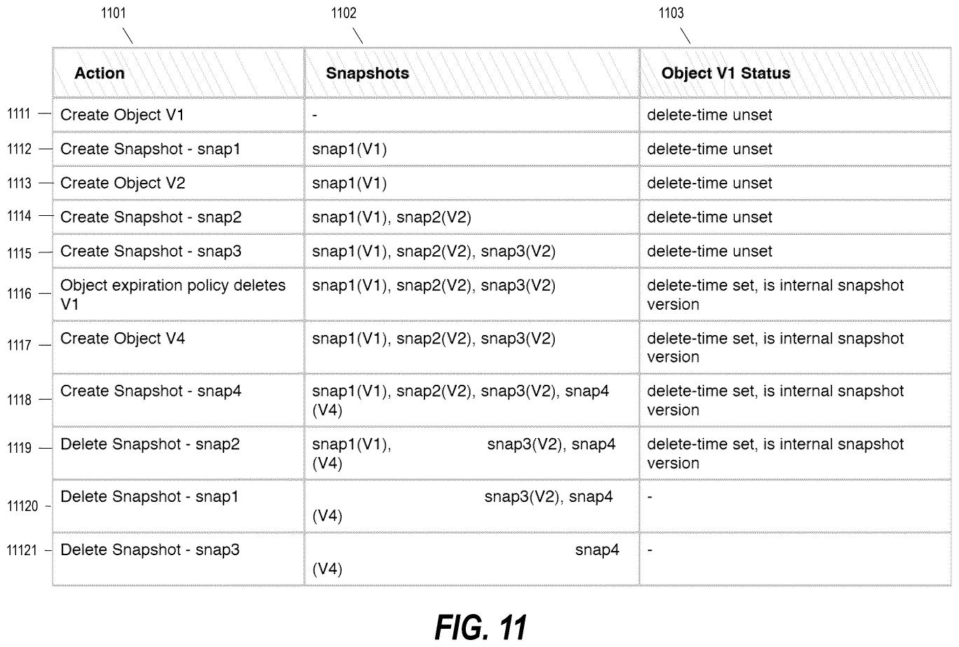

FIG. 11 is a table (or a data structure) illustrating another example scenario of a possible object version workflow for a versioning-enabled bucket (e.g., one of buckets 2040 of FIG. 20) in accordance with one or more embodiments. In the context of the present example, the timeline for the bucket (not shown) runs from top to bottom, so row 1111 occurred earlier in time than subsequent rows 1112-1121. Three columns are shown including an action column 1101, a snapshots column 1102, and an object V1 status column 1103. The action column 1101 indicates a particular action that occurs during the timeframe associated with the particular row. The snapshots column 1102 identifies the existing snapshots and the version of the object protected by such snapshots as of the time associated with the particular row. The object V1 status column 1103 provides information regarding the state of version V1 of the object as of the time associated with the particular row.

At row 1101, a new object is created in which the current version is V1, there are no existing snapshots, and the delete-time of V1 is unset.

At row 1102, a snapshot named “snap1” is created. Snap1 protects the current version (i.e., V1) of the object. The delete-time of V1 remains unset.

At row 1103, version V2 of the object is created. V2 is not protected by snap1 as it was created after the creation time associated with snap1 and therefore could not have been the current version of the object as of the creation time associated with snap1. Meanwhile, the delete-time of V1 remains unset as it has not been explicitly or implicitly deleted. V1 has simply become a prior version at this point in the example.

At row 1104, a second snapshot named “snap2” is created. At this point, snap1 protects V1 and snap2 protects the current version (i.e., V2) of the object as of the creation time associated with snap2.

At row 1105, a third snapshot named “snap3” is created. At this point, snap1 protects V1, snap2 protects V2, and snap3 protects the current version (i.e., V2) of the object as of the creation time associated with snap3. So, V2 is protected by two snapshots.

At row 1106, an object lifecycle policy (e.g., an object expiration policy) deletes V1. At this point, snap1 protects V1 and snap2 and snap3 protect V2. Because snap1 protects V1, its delete-time is set, marking it as a hidden or internal version not currently visible to a client.

At row 1107, version V4 of the object is created. The prior state as existing in row 1106 otherwise remains the same.

At row 1108, a fourth snapshot named “snap4” is created. At this point, snap1 protects V1, snap2 and snap3 protect V2, and snap4 protects the current version (i.e., V4) of the object as of the creation time associated with snap4.

At row 1109, snap2 is deleted. At this point, snap1 continues to protect V1, snap3 continues to protect V2, and snap4 continues to protect V4. Notably, the deletion of snap2 does not result in the deletion of V2 since it is still protected by snap3.

At row 1120, snap1 is deleted. At this point, snap3 continues to protect V2 and snap4 continues to protect V4. Notably, V1 is now permanently deleted as it was a hidden or internal version that is no longer protected by an existing snapshot.

At row 1121, snap3 is deleted. At this point, snap4 is the only remaining snapshot and continues to protect V4. Notably, V2 is now permanently deleted as it is no longer protected by an existing snapshot and therefore can no longer be restored.

### First Example of a Snapshot Metafile

In various examples described herein, the particular version of a given object protected by a given snapshot may be determined on the fly (e.g., at the time it is needed) based on one or more time indicators (e.g., a creation time and a deletion time) associated with the particular version and a time indicator (e.g., a creation time) associated with the given snapshot. According to one embodiment, the creation time associated with a snapshot is stored as part of a snapshot entry within a snapshot metafile. One snapshot metafile may be maintained by the storage system for each bucket maintained by the storage system.

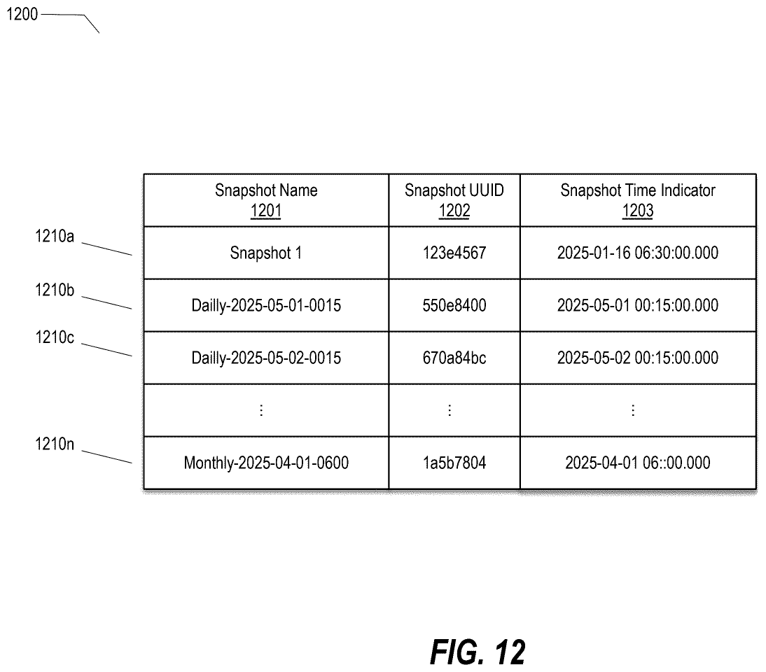

FIG. 12 conceptually illustrates an example of a snapshot metafile 1200 in accordance with one or more embodiments. While for simplicity, in the context of the present example, the snapshot metafile 1200 is conceptually depicted as a two-dimensional table having columns representing a snapshot name 1201, a snapshot UUID 1202, and a snapshot time indicator 1203, it is to be appreciated the snapshot metafile 1200 may be represented differently. For example, in some embodiments, the snapshot metafile 1200 may be in the form of a B+ tree or a V+ tree.

In this example, the snapshot metafile 1200 is shown having n rows 1210a-n. Each row (which may also be referred to herein as a “snapshot entry”) represents a snapshot and includes the name of the snapshot, a UUID of the snapshot, and a time indicator. The name of the snapshot may be specified at the time of snapshot creation, for example, by a storage administrator or client, when manually creating a snapshot or by an internal snapshot creation module of the storage system, for example, that creates snapshots periodically (e.g., hourly, daily, weekly, monthly, etc.) in accordance with snapshot policies established by the storage administrator. The UUID of the snapshot may be created internally by the storage system and may simply represent a monotonically increasing number associated with a particular bucket that is incremented each time a new snapshot is created. The time indicator may represent a creation time associated with the snapshot in the form of a timestamp (e.g., including a date and time) or an epoch.

In some examples, the number of snapshots that may concurrently exist at any given time for a given bucket may be limited to a predefined or configurable number (e.g., 1024).

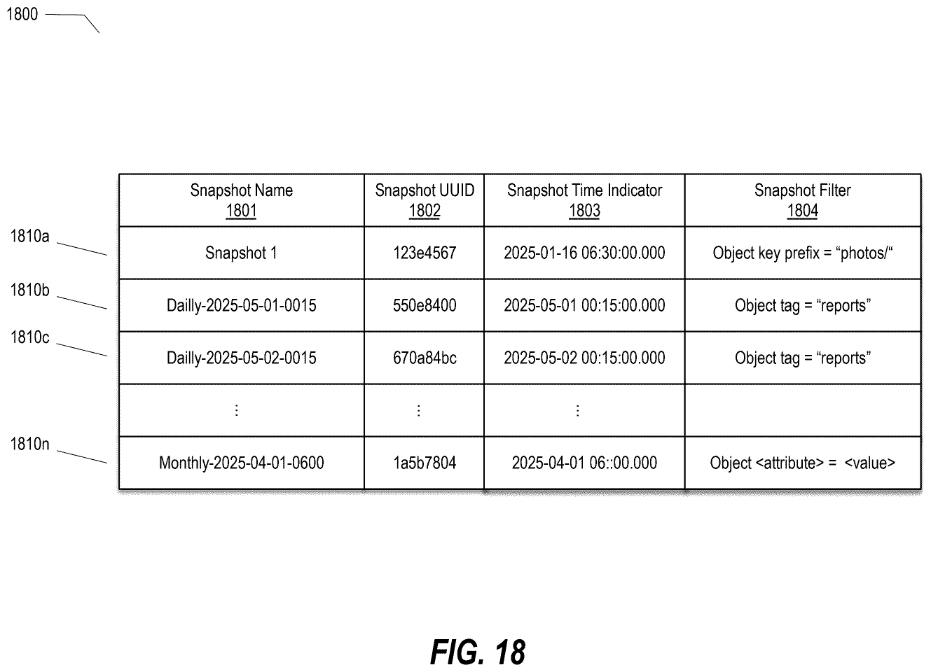

Depending on the particular implementation, one or more of the snapshot name 1201 and the snapshot UUID 1202 may be used as a snapshot ID. As such, in various examples described herein, creation of a snapshot may be accomplished by simply adding a snapshot entry, including the snapshot ID for the snapshot and the creation time indicator for the snapshot, to the snapshot metafile 1200. As those skilled in the art will appreciate, more or fewer snapshot attributes may be included for a snapshot entry. For example, as described further below, for example, with reference to FIG. 18, granular snapshots may be supported by including an additional attribute (e.g., a snapshot filter) may also be included within a snapshot entry.

In one embodiment, the snapshot metafile 1200 may be dual-indexed based on the snapshot name as a first key and the snapshot time indicator as a second key. By using these elements as keys, the storage system may efficiently search for a specific snapshot name and snapshots around a specific time using efficient search algorithms readily available to the data format (e.g., the less-than and greater-than search capabilities). As described further below, with reference to FIG. 13, adding a snapshot entry to the snapshot metafile 1200 may be the only operation needed at snapshot creation time. Meanwhile, when accessing or performing write operations in the current view of the bucket (i.e., in the present time), for example, “list objects,” “put object” (for a name that does not yet exist in the bucket) or “get object,” interaction with the snapshot metafile 1200 may not be needed. As a result, there may be no locking contention on the snapshot metafile 1200 for these operations, thereby allowing snapshot creation to be independent from and have no impact on (e.g., not slow down) common operations for access to current objects in the object-storage based resource.

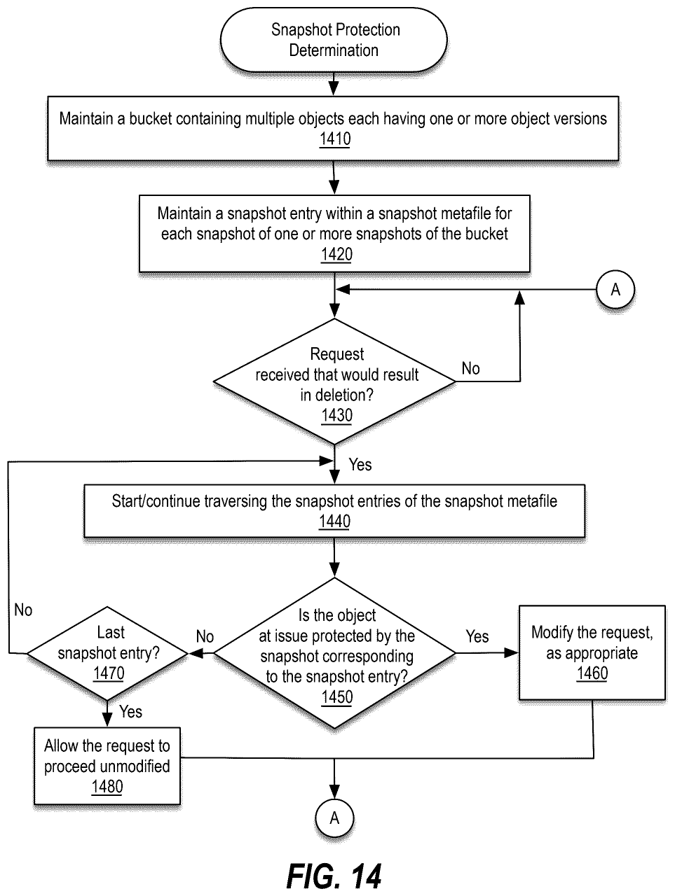

When a request is made to delete a prior object version, the snapshot metafile 1200 may be consulted as part of processing the deletion request. In examples described herein, performance of deletion is configured as an efficient operation, for example, based on the dual-indexing of the snapshot metafile 1200, which enables the storage system to determine quickly and efficiently whether any existing snapshot of the bucket protects the object version being deleted. As described further below with reference to FIG. 14, if the object version is not protected, the deletion is allowed to proceed; otherwise, the object version may be marked as hidden externally but retained internally.

### Example Processing Associated with Snapshot Creation

FIG. 13 is a flow diagram illustrating operations associated with snapshot creation in accordance with one or more embodiments. The processing described with reference to FIG. 13 may be performed by a storage system (e.g., one of nodes 102 of cluster 101, one of nodes 236a-n of cluster 235, or one of virtual storage systems 310a-c).

At block 1310, a bucket (e.g., one of buckets 2040 of FIG. 20) is maintained by the storage system, for example, containing multiple objects each having one or more object versions.

In the context of the present example, it is assumed a request has been received by the storage system to create a snapshot. The snapshot creation request may include an optional snapshot identifier (ID) to be used as a snapshot name and an optional creation time to be associated with the snapshot (if the snapshot is a retroactive snapshot). The optional snapshot ID may be provided in the form of a textual description of a predetermine or configurable length so as to reserve some portion of the snapshot ID for internal system use. If no snapshot ID is specified as part of the snapshot creation request, a UUID created for the new snapshot may be used as the snapshot name. If no creation time is specified as part of the snapshot creation request, the current system time may be used as the creation time. Snapshots may be created manually by a client or a storage system administrator or snapshots may be automatically created based on internal storage system operations. For example, snapshots may be automatically created on a periodic (e.g., hourly, daily, weekly, monthly, etc.) basis, for example, based on snapshot policies defined by a client or a storage system administrator.

At block 1320, a snapshot of the bucket is created by adding a snapshot entry (e.g., one of snapshot entries 1210a-n) to a snapshot metafile (e.g., snapshot metafile 1200) of the bucket. For example, a new snapshot entry may be inserted into the snapshot metafile having a snapshot name (e.g., snapshot name 1201) set to a snapshot ID specified as part of the request or the snapshot UUID generated for the snapshot if no snapshot ID is specified as part of the request and a snapshot creation time (e.g., snapshot time indicator 1203) set to a creation time specified as part of the request or the current system time if no creation time is specified as part of the request.

As noted above, because the particular version of respective objects in the bucket that is protected by a given snapshot may be determined on the fly based on one or more time indicators (e.g., a creation time and a deletion time) associated with respective object versions and the creation time associated with the given snapshot, simply adding a snapshot entry to the snapshot metafile 1200 may be the only operation needed at the time of snapshot creation. For example, using this approach there is no requirement to store, record, or otherwise associate object information (e.g., names of objects and/or current versions thereof) with the snapshot being created. This makes snapshot creation essentially instantaneous as snapshot creation is independent of the contents (e.g., the number of objects and versions thereof) of the bucket, and although the time required to insert this entry into the snapshot data structure or metafile may depend on the number of snapshot entries (corresponding to the current number of existing snapshots of the bucket), the data may scale effortlessly to much larger than hundreds of thousands of entries. In contrast, traditional systems do not allow more than 1024 snapshots.

At block 1330, after creation of the snapshot, those of the one or more object versions of respective objects of the multiple objects existing at a specific point in time indicated by the snapshot time indicator (the creation time) are protected. As noted above, in one embodiment, only the current version of a given object existing at the creation time associated with a given snapshot is protected by the given snapshot. According to one embodiment, protection for the versions of objects owned by an existing snapshot may be performed by explicitly hooking object-modifying operations and allowing or modifying the performance of such operations, as appropriate, at the whole-object level, for example, as described further below, in the case of an implicit or explicit deletion (via an object lifecycle policy or by a client) of a particular version of an object.

As noted above, in one embodiment, a snapshot may protect some or all of the following items (e.g., by ensuring that these items are not deleted or modified):
Object inodes for objects whose time indicator range (e.g., creation time to delete-time range) encompasses the time indicator of the snapshot. This may include previous object versions.
System metadata that is stored in the inode for objects and previous versions captured in the snapshot. This metadata may be obtained from the inode.
Inode labels (e.g., for tags and metadata) for the inodes corresponding to objects and previous versions captured in the snapshot (e.g., by ensuring these labels are not deleted).

### Example Snapshot Protection Determination

FIG. 14 is a flow diagram illustrating operations associated with performing a snapshot protection determination for a particular version of an object in accordance with one or more embodiments. The processing described with reference to FIG. 14 may be performed by a storage system (e.g., one of nodes 102 of cluster 101, one of nodes 236a-n of cluster 235, or one of virtual storage systems 310a-c).

At block 1410, a bucket (e.g., one of buckets 2040 of FIG. 20) is maintained by the storage system, for example, containing multiple objects each having one or more object versions.

At block 1420, a snapshot entry (e.g., one of snapshot entries 1210a-n) is maintained within a snapshot metafile (e.g., snapshot metafile 1200) for each snapshot of one or more snapshots of the bucket.

At decision block 1430, it is determined if a request, for example, an object-modifying operation, received from a client (e.g., one of clients 105, 205, or 305) or a storage administrator, or received as a result of an object lifecycle policy (e.g., expiration of objects after X days) being triggered would result in deletion of a particular object. If so, processing continues with block 1440; otherwise, processing loops back to decision block 1430. As noted above, in some examples object-modifying operations may be explicitly hooked thereby causing the appropriate path through blocks 1430-1480 to be performed inline prior to performing the object-modifying operation at issue.

In the context of the present example, as described further below, if the particular object (e.g., version V3 1013 of FIGS. 10A-B) is protected by any existing snapshot of the bucket, then depending on the type of bucket (e.g., versioned or unversioned), the object-modifying operation at issue (e.g., DeleteObject) may be allowed and modified so as to retain the particular object as a hidden or internal version or may be disallowed.

At block 1440, a traversal of existing snapshots of the bucket is initiated, for example by iterating over the snapshot entries (e.g., 1210a-n) of a snapshot metafile (e.g., snapshot metafile 1200) associated with the bucket.

At block 1450, during each iteration, it is determined whether the particular object at issue is protected by the snapshot corresponding to the current snapshot entry. If so, processing branches to block 1460; otherwise, processing continues with decision block 1470. As noted above, the determination regarding whether a given object is protected by a particular snapshot may be performed based on the creation time of the particular snapshot, the creation time and deletion time (if any) of the given object, and respective creation times and deletion times (if any) of all other existing versions of the object. For example, if the creation time of the particular snapshot is equal to or after the creation time of the given object and equal to or before the deletion time of the given object, and the given version of the object was the current version-had the latest creation time among all existing client-visible versions of the object-as of the creation time of the particular snapshot, then the given object is protected by the particular snapshot; otherwise, the given object is not protected by the particular snapshot.

At block 1460, the request (an object-modifying operation that would otherwise result in deletion of the particular object) is modified as appropriate to preserve desired data while also making it appear to the client that the object-modifying operation has been successfully completed. For example, in the case of a request to delete a specified version of a particular object (e.g., delete version V3 1013 in FIG. 10A) of a versioned bucket, rather than permanently deleting the particular object, one or more attributes (e.g., a deletion time) of the particular object may be modified so as to retain it as a hidden or internal version and make it invisible to the client. At this point, processing for this request is complete. Any subsequent object-modifying operation may be hooked and again result in the performance of the appropriate path through blocks 1440-1480.

At decision block 1470, it is determined whether the current snapshot entry is the last snapshot entry in the snapshot metafile. If so, processing continues with block 1480; otherwise, processing loops back to block 1440 to continue the traversal of the snapshot entries of the snapshot metafile.

At block 1480, the request (an object-modifying operation) is allowed to proceed without modification as the particular object is not protected by any existing snapshot of the bucket. At this point, processing for this request is complete. Any subsequent object-modifying operation may be hooked and again result in the performance of the appropriate path through blocks 1440-1480.

In one embodiment, the operations described with respect to blocks 1440, 1450, and 1470 may be performed as part of an “Is-Object-Protected” routine. For example, an “Is-Object-Protected” function may return true when a specified object version is protected by at least one existing snapshot of the bucket or false when the specified object version is not protected by any existing snapshot of the bucket.

While for convenience and ease of understanding the flow diagram of FIG. 14 shows potential iteration over the entire snapshot metafile, it is to be noted that when the snapshot metafile is dual indexed as described herein, searching may be performed more efficiently. For example, a search for a range of applicable snapshots by time (e.g., timestamp) can be performed to narrow down the range, thereby allowing evaluation of snapshots outside of that range to be avoided.

### Example Snapshot Restore Scenarios

Before moving on to the novel snapshot restore process that makes restoration of a snapshot appear instantaneous and immediately consistent from a client perspective, it is instructive to have a basic understanding of how snapshot restoration works in general. In various examples, the snapshot restore process performs a number of steps, some of which are proportional to how old the restore snapshot is and/or how large the bucket is. As such, a snapshot restore can be a long-running process. According to one embodiment, the snapshot restore process involves the following steps:
Read the snapshot metafile and remove all snapshot records that are newer than the snapshot being restored.
Clear the PCT and MUT.
Iterate through all the chapter and PVT metafiles, and remove all object versions that are later than the snapshot being restored.

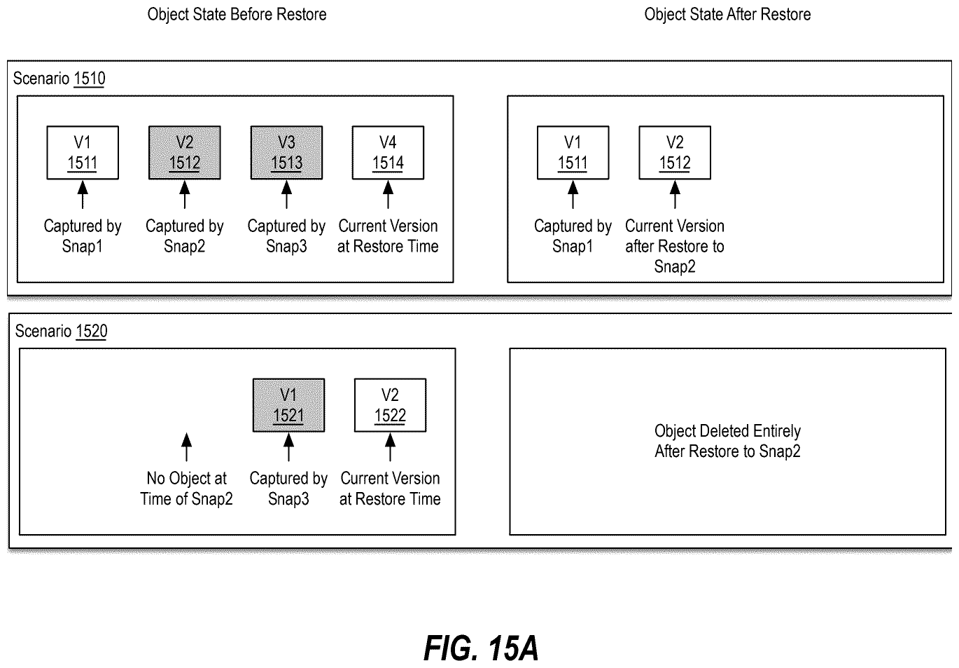

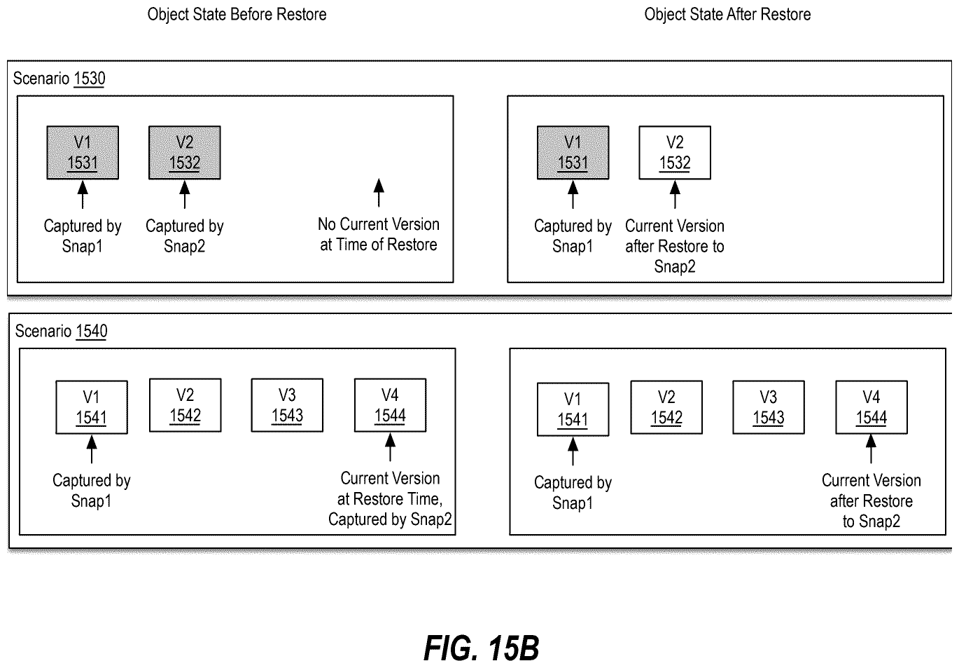

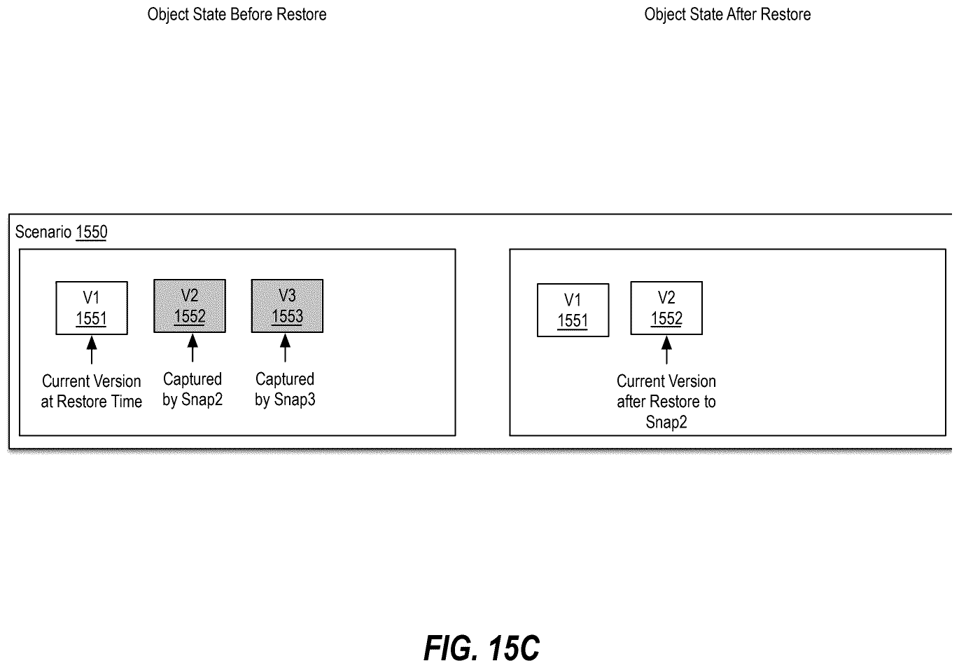

FIGS. 15A-15C are block diagrams illustrating various scenarios and the state of an object before and after performing a snapshot restore in accordance with one or more embodiments. In the context of the present example, the snapshot naming convention is indicative of their relative creation times. For example, Snap1 is created before Snap2, which is created before Snap3. In all scenarios described with reference to FIGS. 15A-15C, an object's state before performing a snapshot restore operation is shown on the left-hand side and the object's state after performing the snapshot restore operation is shown on the right-hand side. As above, in connection with FIGS. 9 and 10A-10B, object versions having a white background are visible to a client of the storage system and object versions having a light gray background are hidden or internal versions that are maintained by the storage system on behalf of the client, for example, to facilitate performance of a “roll back” restore.

Scenario 1510 illustrates expected behavior relating to restoration of a hidden or internal version and the impact on a newer snapshot than the snapshot being restored. In scenario 1510, before performing a restore, prior version V1 1511 (a client-visible version) is captured by a snapshot named “Snap1,” prior version V2 1512 (a hidden or internal version) is captured by a snapshot named “Snap2,” prior version V3 1513 (a hidden or internal version) is captured by a snapshot named “Snap3,” and V4 1514 represents the current version of the object at restore time. After performing the restore to Snap2, prior version V1 1511 remains client visible, prior version V2 1512 is now client visible and has become the current version, and prior version V3 1513 (which was formerly protected by Snap3) has been permanently deleted.

Scenario 1520 illustrates expected behavior relating to restoration of a snapshot for which no object existed as of the create time associated with the snapshot as well as the impact on a newer snapshot than the snapshot being restored. In scenario 1520, before performing a restore, there was no object in existence and hence no object captured by a snapshot named “Snap2,” prior version V1 1521 (a hidden or internal version) is captured by a snapshot named “Snap3,” and V2 1522 represents the current version of the object at restore time. After performing the restore to Snap2, the object is deleted in its entirety. For example, V1 1521 and V2 1522 are permanently deleted.

Scenario 1530 illustrates expected behavior relating to restoration of a hidden or internal version. In scenario 1530, before performing a restore, prior version V1 1531 (a hidden or internal version) is captured by a snapshot named “Snap1,” prior version V2 1532 (a hidden or internal version) is captured by a snapshot named “Snap2,” and no current version of the object exists at restore time. After performing the restore to Snap2, prior version V1 1531 remains as a hidden or internal version that is captured by Snap1 and V2 1532 is now client visible and has become the current version.

Scenario 1540 illustrates expected behavior relating to restoration of the current version and the impact on an older snapshot than the snapshot being restored. In scenario 1540, before performing a restore, prior versions V1 1541, V2 1542, and V3 1543 are all client visible, V1 1541 is captured by a snapshot named “Snap1,” and V4 (captured by a snapshot named “Snap2”) represents the current version of the object at restore time. After performing the restore to Snap2, the object state remains the same-prior versions V1 1541, V2 1542, and V3 1543 all remain client visible, V1 1541 remains protected by Snap1, and V4 remains protected by Snap2 and remains the current version of the object

Scenario 1550 illustrates expected behavior relating to restoration of a prior version that has a newer creation time than the current visible version. In scenario 1550, before performing a restore, V1 1551 represents the current version at restore time, prior version V2 1552 (a hidden or internal version) is captured by a snapshot named “Snap2,” and prior version V3 1553 (a hidden or internal version) is captured by a snapshot named “Snap3.” After performing the restore to Snap2, V1 1551 remains as client visible, prior version V2 1552 is now client visible and has become the current version, and prior version V3 1553 (which was formerly protected by Snap3) has been permanently deleted.

### Example Processing Associated with Performing a Snapshot Restoration

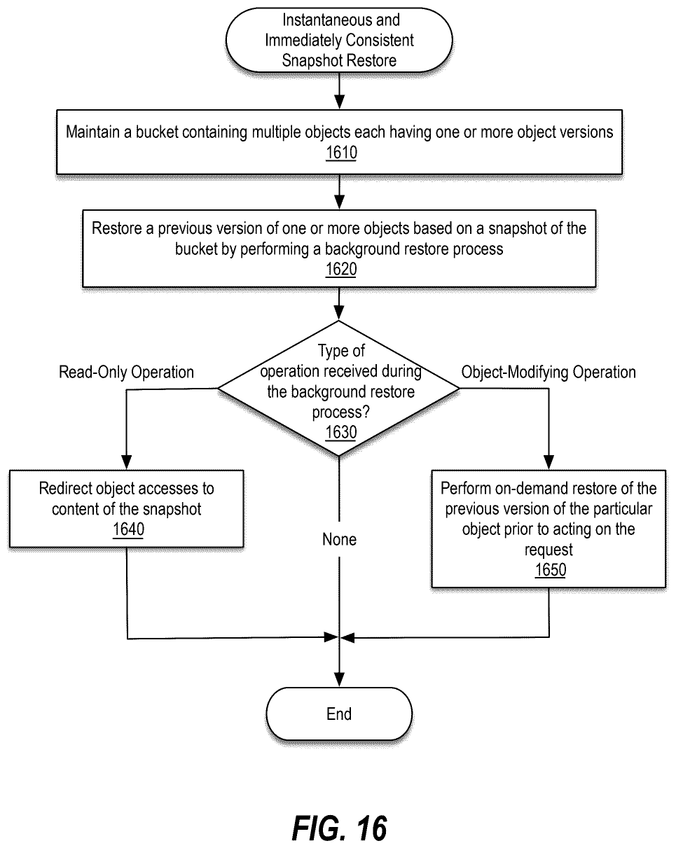

FIG. 16 is a flow diagram illustrating operations associated with performing a snapshot restore that appears instantaneously and immediately consistent from a client perspective in accordance with one or more embodiments. The processing described with reference to FIG. 16 may be performed by a storage system (e.g., one of nodes 102 of cluster 101, one of nodes 236a-n of cluster 235, or one of virtual storage systems 310a-c). As noted above, a snapshot restore process may be a long-running process. Therefore, snapshot restore may use a background job to monitor the steps of the snapshot restore process, which will continue running until all objects have been restored. In one embodiment, the snapshot restore is driven either by a command-line interface (CLI) or a Representational State Transfer (REST) API. According to one embodiment, the snapshot restore will appear nearly instant to a client, with a background process performing the bulk of the restore processing. In one example, client traffic is temporarily paused during the “nearly instant” first phase of the restore (during which client-initiated object protocol operations will fail) but will be allowed to resume during the second phase of background processing and will provide predictable/consistent semantics. For example, reads will return the restored content, writes will correctly overwrite restored content if necessary, etc. In one embodiment, conflicting snapshot operations are prevented during performance of a snapshot restore. For example, only one snapshot restore operation may be allowed at a given time. Similarly, deletion of the snapshot being restored may be precluded until the snapshot restore operation has been completed.

At block 1610, a bucket (e.g., one of buckets 2040 of FIG. 20) is maintained by the storage system, for example, containing multiple objects each having one or more object versions.

At block 1620, a snapshot restore operation is performed to restore a previous version of one or more objects based on a snapshot of the bucket by performing a background restore process. In one embodiment, a fast restore may be accomplished by marking the bucket or the objects as needing a restore and then restoring the objects on-demand and in the background. The background restore process may be run to incrementally restore objects in the bucket according to the information stored in a snapshot entry (e.g., one of snapshot entries 1210a-n) of snapshot metafile (e.g., snapshot metafile 1200) corresponding to the snapshot. In one embodiment, the restore process may be implemented through a specialty object iteration engine (e.g., object iteration engine 2033 of FIG. 20), for example, that builds a list of restore work items using the snapshot entry corresponding to the snapshot and tracks the progress of those items using a secondary index in a chapter database. Alternatively, the object iteration engine can iterate each object in the chapter database and compare the current version of the object with the version referenced by the snapshot entry corresponding to the snapshot. If the versions are different, the object iteration engine may replace the current object with the prior version.

In one example, during the background restore process, various read-only operations (e.g., object enumeration and the like) and object-modifying operations (e.g., “put object,” “delete object,” and “put object tagging”) may be explicitly hooked to facilitate providing the appearance to the client of the restore being performed instantaneously and the contents of the bucket being immediately consistent with the contents of the snapshot being restored by performing the appropriate path through blocks 1630-1650 for each hooked operation.

At decision block 1630, the type of operation received during the background restore process is determined. If no operations are received during the background snapshot restore process, then processing is complete, when a read-only operation is received, then processing branches to block 1640, and when a modifying operation is received, then processing continues with block 1650.

At block 1640, in order to make the contents of the bucket appear immediately consistent with the contents of the snapshot being restored, object accesses may be redirected to content of the snapshot. For example, in one embodiment, the bucket may be mapped with a “redirect snapshot ID” to allow the storage system to redirect all object access to the snapshot content.

At block 1650, in order to make the snapshot restore operation appear instantaneous, responsive to receipt of a request to perform an object-modifying operation, an on-demand restore of the previous version of the particular object of the bucket that is the target of the object-modifying operation may be performed prior to acting on the request. For example, if the previous version of the particular object has not yet been restored to the bucket by operation of the background restore process, which may be a long-running process, the previous version of the particular object may be restored to make it available for the object-modifying operation by performing an immediate restoration of the previous version of the particular object before allowing the object-modifying operation to proceed. In this manner, previous versions of objects being restored based on the snapshot at issue are made available as soon as or whenever required.

This approach reduces client-visible outage and improves the consistency of what clients see—once the recovery is initiated, all accesses will only see the older (snapshot) content. This also makes snapshot recovery appear instant and immediately consistent from a client perspective, even if in reality a background process is operating on the storage system to make sure every object is restored within a reasonable period. This is different than prior implementations which may perform a client-initiated traversal of all objects in a bucket to restore all objects or a subset of objects to a previous version. In doing so, other storage service clients accessing the bucket during the traversal may see a mix of new and old content if they are viewing more than one object. While permissions could be used to temporarily prevent access to the bucket by users other than the backup application until the recovery is complete, this temporary access denial may create an extended outage for other bucket users.

### Example Granular Snapshots

Consistent with the present disclosure, embodiments of the present snapshot implementation may offer flexible object selection for various snapshot operations, including snapshot creation and recovery, in which the objects being recovered are a subset of those that were protected in the snapshot. For example, the storage system may support a request of the nature “create a snapshot at time 20240228.123546 of all objects with tag ‘important-project’” or “create a snapshot at time 20240228.123546 of all objects larger than 10 MB”. The additional creation query may then be associated with the snapshot and/or stored as part of the snapshot definition as a snapshot filter.

In general, any attribute of an object that is immutable could be used as a creation query filter type. The attribute should be immutable because an object should not be able to be retroactively added to or removed from a snapshot (e.g., if the attribute being used as a snapshot filter is modified on the object and changes its inclusion in the snapshot).

The following object attributes are immutable and could be used (alone, or in combination), for snapshot filtering:
Object key prefix (e.g., objects with a prefix equal to X, greater than X, less than X, and so on).
Whether or not the object is singleton or multipart (e.g. only singleton objects, only multipart objects)
Object “type” (e.g., whether the object is a version or null version, whether it is a delete marker or not, etc.)
Object size (e.g., objects smaller than size X, objects larger than size X)
Object creation time, reported as “Last Modified” in AWS (e.g., objects created before time X, objects created after time X)
Object entity tag (etag), which is a hash of its contents (e.g., objects with an etag equal to X or an etag not equal to X)
Object tags (e.g., objects with a specific value for a given tag key, objects with any value for a given tag key, objects not having a given tag key)
   Tags are a bit of a special case, since they are not immutable; however, assuming the tags in effect at the time of a snapshot were captured, this would have the effect of making the tags immutable at that point in time, even if they aren't immutable overall, and therefore the saved tags could be used as a stable basis for a snapshot filter at that specific point in time. Objects whose tags change and cause them to be included or excluded from the snapshot will take effect for future snapshots with that filter, but will not retroactively change the existing snapshot.

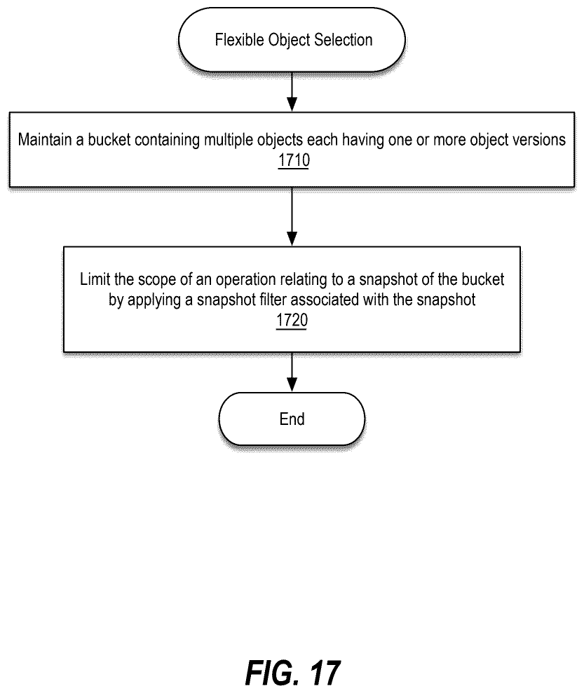

FIG. 17 is a flow diagram illustrating operations associated with performing flexible object selection in connection with an operation relating to a snapshot in accordance with one or more embodiments. The processing described with reference to FIG. 17 may be performed by a storage system (e.g., one of nodes 102 of cluster 101, one of nodes 236a-n of cluster 235, or one of virtual storage systems 310a-c).

At block 1710, a bucket (e.g., one of buckets 2040 of FIG. 20) is maintained by the storage system, for example, containing multiple objects each having one or more object versions.

At block 1720, the scope of an operation requested to be performed relating to a snapshot of the bucket is limited. According to one embodiment, when a snapshot is created an additional filter-the snapshot filter, for example, in the form of an object key prefix or one or more other immutable object attributes (alone, or in combination) may be passed in from the CLI/REST API (or specified in a snapshot policy, for scheduled snapshots). The additional filter may then be associated with the snapshot, for example, storing the additional filter in a “snapshot filter” field within a snapshot entry of a snapshot metafile corresponding to the snapshot. A non-limiting example of a snapshot metafile that may be used for granular snapshots is described below with reference to FIG. 18.

For snapshot operations like snapshot browsing, object version deletion, and recovery, the storage system may first narrow down the correct version using the snapshot time indicator, then the version may be checked against the additional query (e.g., defined by the snapshot filter associated with the snapshot) to determine whether it is covered by the snapshot. This method improves upon prior snapshot implementations because any subset of objects that can be identified may be protected by a snapshot without having to go and find them all at creation time. The storage system may simply track the desired query and take a just-in-time approach to determining snapshot membership when needed (deleting versions, recovery, browsing, etc.).

In one embodiment, the use of a snapshot filter has no effect on snapshot deletion. The enhanced metafile record (the snapshot entry) is simply deleted as usual and a snapshot deletion scan will evaluate all objects for unprotected hidden versions to delete.

When enumerating a snapshot bucket as part of a snapshot browsing operation, the snapshot filter associated with the snapshot is used to exclude any objects that are not applicable to the snapshot, before applying the logic that determines the correct version (if any) of each object to return. Only objects that match the snapshot filter will be visible in the snapshot bucket. Attempting to read an individual object that is excluded by the snapshot will act as though the object doesn't exist.

Snapshot recovery may also benefit from flexible object selection in a similar fashion. The object selection may not need to match the query from when the snapshot was created, as long as it is a subset of the objects that were protected. If no filter is specified as part of the operation, the snapshot recovery will use the original snapshot filter from the snapshot being restored. The tables and processing engines that control restore will be passed the appropriate filter. This will be used to determine which objects should be marked for restore. Unlike a whole-bucket restore, this style of restore cannot be a “roll back” restore (where the objects are taken back in time) and must be a “roll forward” restore (where objects are restored by overwriting them with the restore version). This is because newer snapshots at different granularities may exist and protect newer versions of some of the objects affected by the restore. This type of restore will also not delete newer snapshots.

Objects to which the restore filter does not apply are untouched by the restore process (they are not deleted). Objects to which the restore filter does apply, but which are not in the snapshot being restored, are overwritten with a delete marker so that they appear deleted. Objects to which the restore filter does apply and which have a version in the snapshot being restored, will be restored to that version by copying that version to be the latest version (this can be done efficiently using server-side object copy)

In one embodiment, the recovery query may be provided to a specialty object iteration engine (e.g., object iteration engine 2033 of FIG. 20) as part of a recovery task and the object iteration engine may apply the recovery query to each object as it is evaluated for recovery.

While in the context of the flow diagrams of FIGS. 13-14 and 16-17 a number of enumerated blocks are included, it is to be understood that examples may include additional blocks before, after, and/or in between the enumerated blocks. Similarly, in some examples, one or more of the enumerated blocks may be omitted and/or performed in a different order.

### Second Example of a Snapshot Metafile

In various examples described herein, granular snapshots are supported by facilitating flexible object selection. Prior client-side snapshot implementations can snapshot only objects starting with a specific prefix relatively efficiently, for example, since some storage services offer prefix filtering. To select a subset of objects in the bucket to snapshot based on other criteria, however, such prior client-side implementations would have to request and examine the properties of every object in the bucket in order to determine if that object should be included in the snapshot. On the other hand, by using a storage system-integrated approach (or server-integrated approach), snapshot implementations consistent with various embodiments, may offer more flexibility in object selection beyond the filtering that is available to users through storage service APIs. For example, the present snapshot implementation may be defined to protect all objects with a specific tag, metadata, or any other property visible on the storage system and the filter (the object-selection mechanism used to perform the object selection) may be stored within the snapshot entry of the snapshot metafile corresponding to the snapshot at issue as described with reference to FIG. 18.

FIG. 18 conceptually illustrates another example of a snapshot metafile 1800 in accordance with one or more embodiments. Snapshot metafile 1800 generally corresponds to snapshot metafile 1200 other than the inclusion of an additional column (i.e., snapshot filter 1804). As noted above with reference to snapshot metafile 1200 of FIG. 12, while for simplicity, in the context of the present example, the snapshot metafile 1800 is conceptually depicted as a two-dimensional table having columns representing a snapshot name 1801 (which may be analogous to snapshot name 1201), a snapshot UUID 1802 (which may be analogous to snapshot UUID 1202), and a snapshot time indicator 1803 (which may be analogous to snapshot time indicator 1203), and a snapshot filter 1804, it is to be appreciated the snapshot metafile 1800 may be represented differently. For example, in some embodiments, the snapshot metafile 1800 may be in the form of a B+ tree or a V+ tree.

In this example, the snapshot metafile 1800 is shown having n rows 1810a-n. Each row (which may also be referred to herein as a “snapshot entry”) represents a snapshot and includes the name of the snapshot, a UUID of the snapshot, a time indicator, and a filter (e.g., snapshot filter 1804). The filter may be specified at the time of snapshot creation, for example, by a storage administrator or client, when manually creating a snapshot or by an internal snapshot creation module of the storage system, for example, that creates snapshots periodically (e.g., hourly, daily, weekly, monthly, etc.) in accordance with snapshot policies established by the storage administrator.

As with snapshot metafile 1200, snapshot metafile 1800 may be dual-indexed based on the snapshot name as a first key and the snapshot time indicator as a second key. By using these elements as keys, the storage system may efficiently search for a specific snapshot name and snapshots around a specific time using efficient search algorithms readily available to the data format (e.g., the less-than and greater-than search capabilities). As described above, adding a snapshot entry to the snapshot metafile 1800 may be the only operation needed at snapshot creation time. Meanwhile, as also described above, when accessing or performing write operations in the current view of the bucket, interaction with the snapshot metafile 1800 may not be needed. As a result, there may be no locking contention on the snapshot metafile 1800 for these operations, thereby allowing snapshot creation to be independent from and have no impact on (e.g., not slow down) common operations for access to current objects in the object-storage based resource.

### Example Network Environment

FIG. 19 is a block diagram illustrating an example of a network environment 1900 in accordance with one or more embodiments. Network environment 1900 illustrates a non-limiting architecture for implementing a distributed storage system (e.g., cluster 101 or 235). The embodiments described above may be implemented within one or more storage apparatuses, such as any single or multiple ones of data storage apparatuses 1902a-n of FIG. 19. For example, the multitiered namespace 400 and the V+ tree described with reference to FIG. 7 may be implemented within node computing devices 1906a-n and/or data storage nodes 1910a-n. In one or more embodiments, nodes 102 may be implemented in a manner similar to node computing devices 1906a-n and/or data storage nodes 1910a-1910n.

Network environment 1900, which may take the form of a clustered network environment, includes data storage apparatuses 1902a-n that are coupled over a cluster or cluster fabric 1904 that includes one or more communication network(s) and facilitates communication between data storage apparatuses 1902a-n (and one or more modules, components, etc. therein, such as, node computing devices 1906a-n (also referred to as node computing devices), for example), although any number of other elements or components can also be included in network environment 1900 in other examples. This technology provides a number of advantages including methods, non-transitory computer-readable media, and computing devices that implement the techniques described herein.

In this example, node computing devices 1906a-n may be representative of primary or local storage controllers or secondary or remote storage controllers that provide client devices 908a-n (which may also be referred to as client nodes and which may be analogous to clients 105, 205, and 305) with access to data stored within data storage nodes 1910a-n (which may also be referred to as data storage devices) and cloud storage node(s) 1936 (which may also be referred to as cloud storage device(s) and which may be analogous to hyperscale disks 325). The node computing devices 1906a-n may be implemented as hardware, software (e.g., a storage virtual machine), or combination thereof.

Data storage apparatuses 1902a-n and/or node computing devices 1906a-n of the examples described and illustrated herein are not limited to any particular geographic areas and can be clustered locally and/or remotely via a cloud network, or not clustered in other examples. Thus, in one example data storage apparatuses 1902a-n and/or node computing devices 1906a-n can be distributed over multiple storage systems located in multiple geographic locations (e.g., located on-premise, located within a cloud computing environment, etc.); while in another example a network can include data storage apparatuses 1902a-n and/or node computing devices 1906a-n residing in the same geographic location (e.g., in a single on-site rack).

In the illustrated example, one or more of client devices 1908a-n, which may be, for example, personal computers (PCs), computing devices used for storage (e.g., storage servers), or other computers or peripheral devices, are coupled to the respective data storage apparatuses 1902a-n by network connections 1912a-n. Network connections 1912a-n may include a local area network (LAN) or wide area network (WAN) (i.e., a cloud network), for example, that utilize TCP/IP and/or one or more Network Attached Storage (NAS) protocols, such as a Common Internet Filesystem (CIFS) protocol or a Network Filesystem (NFS) protocol to exchange data packets, a Storage Area Network (SAN) protocol, such as Small Computer System Interface (SCSI) or Fiber Channel Protocol (FCP), an object protocol, such as simple storage service (S3), and/or non-volatile memory express (NVMe), for example.

Illustratively, client devices 1908a-n may be general-purpose computers running applications and may interact with data storage apparatuses 1902a-n using a client/server model for exchange of information. That is, client devices 1908a-n may request data from data storage apparatuses 1902a-n (e.g., data on one of the data storage nodes 1910a-n managed by a network storage controller configured to process I/O commands issued by client devices 1908a-n, and data storage apparatuses 1902a-n may return results of the request to client devices 1908a-n via the network connections 1912a-n.

The node computing devices 1906a-n of data storage apparatuses 1902a-n can include network or host nodes that are interconnected as a cluster to provide data storage and management services, such as to an enterprise having remote locations, cloud storage (e.g., a storage endpoint may be stored within cloud storage node(s) 1936), etc., for example. Such node computing devices 1906a-n can be attached to the cluster fabric 1904 at a connection point, redistribution point, or communication endpoint, for example. One or more of the node computing devices 1906a-n may be capable of sending, receiving, and/or forwarding information over a network communications channel, and could comprise any type of device that meets any or all of these criteria.

In an example, the node computing devices 1906a-n may be configured according to a disaster recovery configuration whereby a surviving node provides switchover access to the storage devices 1910a-n in the event a disaster occurs at a disaster storage site (e.g., the node computing device 1906a provides client device 1908n with switchover data access to data storage nodes 1910n in the event a disaster occurs at the second storage site). In other examples, the node computing device 1906n can be configured according to an archival configuration and/or the node computing devices 1906a-n can be configured based on another type of replication arrangement (e.g., to facilitate load sharing). Additionally, while two node computing devices are illustrated in FIG. 19, any number of node computing devices or data storage apparatuses can be included in other examples in other types of configurations or arrangements.

As illustrated in network environment 1900, node computing devices 1906a-n can include various functional components that coordinate to provide a distributed storage architecture. For example, the node computing devices 1906a-n can include network modules 1914a-n and disk modules 1916a-n. Network modules 1914a-n can be configured to allow the node computing devices 1906a-n (e.g., network storage controllers) to connect with client devices 1908a-n over the network connections 1912a-n, for example, allowing client devices 1908a-n to access data stored in network environment 1900.

Further, the network modules 1914a-n can provide connections with one or more other components through the cluster fabric 1904. For example, the network module 1914a of node computing device 1906a can access the data storage node 1910n by sending a request via the cluster fabric 1904 through the disk module 1916n of node computing device 1906n when the node computing device 1906n is available. Alternatively, when the node computing device 1906n fails, the network module 1914a of node computing device 1906a can access the data storage node 1910n directly via the cluster fabric 1904. The cluster fabric 1904 can include one or more local and/or wide area computing networks (i.e., cloud networks) embodied as Infiniband, Fibre Channel (FC), or Ethernet networks, for example, although other types of networks supporting other protocols can also be used.

Disk modules 1916a-n can be configured to connect data storage nodes 1910a-n, such as disks or arrays of disks, SSDs, flash memory, or some other form of data storage, to the node computing devices 1906a-n. Often, disk modules 1916a-n communicate with the data storage nodes 1910a-n according to a SAN protocol, such as SCSI or FCP, for example, although other protocols can also be used. Thus, as seen from an OS on node computing devices 1906a-n, the data storage nodes 1910a-n can appear as locally attached. In this manner, different node computing devices 1906a-n, etc. may access data blocks, files, or objects through the OS, rather than expressly requesting abstract files.

While network environment 1900 illustrates an equal number of network modules 1914a-n and disk modules 1916a-n, other examples may include a differing number of these modules. For example, there may be a plurality of network and disk modules interconnected in a cluster that do not have a one-to-one correspondence between the network and disk modules. That is, different node computing devices can have a different number of network and disk modules, and the same node computing device can have a different number of network modules than disk modules.

Further, one or more of client devices 1908a-n can be networked with the node computing devices 1906a-n in the cluster, over the network connections 1912a-n. As an example, respective client devices 1908a-n that are networked to a cluster may request services (e.g., exchanging of information in the form of data packets) of node computing devices 1906a-n in the cluster, and the node computing devices 1906a-n can return results of the requested services to client devices 1908a-n. In one example, client devices 1908a-n can exchange information with the network modules 1914a-n residing in the node computing devices 1906a-n (e.g., network hosts) in data storage apparatuses 1902a-n.

In one example, storage apparatuses 1902a-n host aggregates corresponding to physical local and remote data storage devices, such as local flash or disk storage in the data storage nodes 1910a-n, for example. One or more of the data storage nodes 1910a-n can include mass storage devices, such as disks of a disk array. The disks may comprise any type of mass storage devices, including but not limited to magnetic disk drives, flash memory, and any other similar media adapted to store information, including, for example, data and/or parity information.

The aggregates may include volumes 1918a-n in this example, although any number of volumes can be included in the aggregates. The volumes 1918a-n are virtual data stores or storage objects that define an arrangement of storage and one or more filesystems within network environment 1900. Volumes 1918a-n can span a portion of a disk or other storage device, a collection of disks, or portions of disks, for example, and typically define an overall logical arrangement of data storage. In one example volumes 1918a-n can include stored user data as one or more files, blocks, or objects that may reside in a hierarchical directory structure within the volumes 1918a-n.

Volumes 1918a-n are typically configured in formats that may be associated with particular storage systems, and respective volume formats typically comprise features that provide functionality to the volumes 1918a-n, such as providing the ability for volumes 1918a-n to form clusters, among other functionality. Optionally, one or more of the volumes 1918a-n can be in composite aggregates and can extend between one or more of the data storage nodes 1910a-n and one or more of the cloud storage node(s) 1936 to provide tiered storage, for example, and other arrangements can also be used in other examples.

In one example, to facilitate access to data stored on the disks or other structures of the data storage nodes 1910a-n, a filesystem (e.g., file system layer 311) may be implemented that logically organizes the information as a hierarchical structure of directories and files. In this example, respective files may be implemented as a set of disk blocks of a particular size that are configured to store information, whereas directories may be implemented as specially formatted files in which information about other files and directories are stored.

Data can be stored as files or objects within a physical volume and/or a virtual volume, which can be associated with respective volume identifiers. The physical volumes correspond to at least a portion of physical storage devices, such as the data storage nodes 1910a-n (e.g., a RAID system, such as RAID layer 313) whose address, addressable space, location, etc. does not change.

Typically, the location of the physical volumes does not change in that the range of addresses used to access it generally remains constant.

Virtual volumes, in contrast, can be stored over an aggregate of disparate portions of different physical storage devices. Virtual volumes may be a collection of different available portions of different physical storage device locations, such as some available space from disks, for example. It will be appreciated that since the virtual volumes are not “tied” to any one particular storage device, virtual volumes can be said to include a layer of abstraction or virtualization, which allows it to be resized and/or flexible in some regards.

Further, virtual volumes can include one or more LUNs, directories, Qtrees, files, and/or other storage objects, for example. Among other things, these features, but more particularly the LUNs, allow the disparate memory locations within which data is stored to be identified, for example, and grouped as data storage unit. As such, the LUNs may be characterized as constituting a virtual disk or drive upon which data within the virtual volumes is stored within an aggregate. For example, LUNs are often referred to as virtual drives, such that they emulate a hard drive, while they actually comprise data blocks stored in various parts of a volume.

In one example, the data storage nodes 1910a-n can have one or more physical ports, wherein each physical port can be assigned a target address (e.g., SCSI target address). To represent respective volumes, a target address on the data storage nodes 1910a-n can be used to identify one or more of the LUNs. Thus, for example, when one of the node computing devices 1906a-n connects to a volume, a connection between the one of the node computing devices 1906a-n and one or more of the LUNs underlying the volume is created.

Respective target addresses can identify multiple of the LUNs, such that a target address can represent multiple volumes. The I/O interface, which can be implemented as circuitry and/or software in a storage adapter or as executable code residing in memory and executed by a processor, for example, can connect to volumes by using one or more addresses that identify the one or more of the LUNs.

The present embodiments can take the form of an entirely hardware embodiment, an entirely software embodiment, or an embodiment containing both hardware and software elements. Accordingly, it is understood that any operation of the computing systems of the network environment 1900 and the distributed storage system (e.g., cluster 101, cluster 235, and/or a cluster of virtual storage systems 310a-c) may be implemented by a computing system using corresponding instructions stored on or in a non-transitory computer-readable medium accessible by a processing system. For the purposes of this description, a non-transitory computer-usable or computer-readable medium can be any apparatus that can store the program for use by or in connection with the instruction execution system, apparatus, or device. The medium may include non-volatile memory including magnetic storage, solid-state storage, optical storage, cache memory, and RAM.

### Example Object Model

FIG. 20 is a block diagram conceptually illustrating various functional units of a storage system (e.g., storage system 2000) that may be used to implement bucket-level snapshots in accordance with one or more embodiments. The storage system may be analogous to one of nodes 102 of cluster 101, one of nodes 236a-n of cluster 235, or one of virtual storage systems 310a-c. Notably, functional units of storage system 2000 described herein are meant only to exemplify various possibilities. In no way should example storage system 2000 limit the scope of the present disclosure. In the context of the present example, the storage system is shown including an M-host (e.g., M-host 2010), an N-blade (e.g., N-blade 2020, which may be analogous to one of network modules 1914a-n), and a D-blade (e.g., D-blade 2030, which may be analogous to one of disk modules 1219a-n).

The M-host may represent a user-space process that facilitates various management activities on the storage system. In this example, the M-host is shown including a snapshot policy module 2013, a command-line interface (CLI) module 2011 module, a Representational State Transfer (REST) API 2012, and a snapshot jobs module 2014. The snapshot policy module 2013 may be responsible for handling how and when bucket-level snapshots are created (e.g., hourly, daily, or weekly), retained, and potentially deleted, for example, including controlling the frequency of snapshots, how many to copies to keep, and potentially how to name the snapshots. This allows a storage administrator (e.g., storage administrator 2001) to automate the creation and management of snapshots for data protection and recovery. Default policies may be provided that offer a basic level of data protection, while also allowing for customization.

The CLI module 2011 may be responsible for providing a mechanism through which the system administrator may interact with the storage system, configure the storage system, and/or monitor the status of the storage system using text-based commands. The REST API may expose various functions (e.g., operations on buckets, snapshots, and/or objects) and data (e.g., the contents of buckets, snapshots, and/or objects) of the storage system available for use by the storage administrator and/or clients (e.g., client 2005, which may be analogous to one of clients 105, 205, or 305) of the storage system. The snapshot jobs module 2014 may be responsible for directing the D-Blade to take action based on input received from the snapshot policy module 2013, the CLI module, or the REST API 2012.

The N-blade is shown including an object protocol and commands module 2025 that may be responsible for handling the specific details of one or more object protocols (e.g., the AWS S3 protocol) implemented by the storage system. The object protocol and commands module 2025 may provide commands for interacting with buckets (e.g., buckets 2040), including commands for allowing clients to manage objects within buckets.

The D-blade is shown including a kernel services and management functions (KSMF) module 2031, a spinNP module 2032, an object iteration engine 2033, one or more bucket(s) 2040, an object volume interface 2034, and file system, RAID, and storage layers 2051 (which may be analogous to file system layer 311, RAID layer 313, and storage layer 315). The KSMF module 2031 may be responsible for, among other things, providing a set of services and functionalities that manage and maintain the overall health and performance of the storage system and services for data integrity, reliability, and availability, including features like data replication, snapshots, and data migration. The spinNP module 2032 may represent a family of message-passing protocols used for high-traffic communication with a cluster of storage systems, for example, providing a way for different parts of the cluster (e.g., N-blades and D-blades) to communicate with each other efficiently.

The object iteration engine 2033 may include infrastructure that maintains accounting information on a per-object basis that allows for efficient iteration over all or a subset of objects in a bucket. The object iteration engine 2033 may be responsible for making available various mechanisms for iterating over all or a specified list of objects in a bucket and performing processing specified by a requester on those of the objects meeting certain criteria. For example, the object iteration engine 2033 may expose a work queue (not shown) on to which a requester may add directives (e.g., recover the objects protected by a specified snapshot). Additionally, the object iteration engine 2033 may offer cadence iteration, for example, which may be used to continuously or periodically iterate over all objects in a bucket as part of deletion, for example, to determine whether something (e.g., one or more objects in the bucket) can be removed to free up space.

The storage system may maintain one or more buckets 2040 and associated data structures, databases, metafile, and data. In the context of the present example, each bucket may maintain a TOC 2041 (which may be analogous to one of TOCs 510, 610, or 710), one or more chapters 2042 (which may be analogous to chapters 550a-n, 650a-n, or 750a-n), a snapshot metafile 2043 (which may be analogous to snapshot metafile 1200 or 1800), a PVT 2044 (which may be analogous to one of PVTs 7611, 762, or 862), and associated objects 2045 (e.g., the objects and versions described with reference to FIGS. 4-11 and 15). In other examples, the TOC 2041 may be maintained on a per-flexgroup volume basis and may contain information regarding chapters for all buckets in that volume.

### Example Computer System

Various components of the present embodiments described herein may include hardware, software, or a combination thereof. Accordingly, it may be understood that in other embodiments, any operation of a distributed storage management system (e.g., the cluster 101, cluster 235, and/or a cluster including virtual storage systems 310a-c) or one or more of its components thereof may be implemented using a computing system via corresponding instructions stored on or in a non-transitory computer-readable medium accessible by a processing system. For the purposes of this description, a tangible computer-usable or computer-readable medium can be any apparatus that can store the program for use by or in connection with the instruction execution system, apparatus, or device. The medium may include non-volatile memory including magnetic storage, solid-state storage, optical storage, cache memory, and RAM.

The various systems and subsystems (e.g., file system layer 311, RAID layer 313, and storage layer 315), and/or nodes 102 (when represented in virtual form) of the distributed storage system described herein, and the processing described herein may be implemented in the form of executable instructions stored on a machine readable medium and executed by a processing resource (e.g., a microcontroller, a microprocessor, central processing unit core(s), an application-specific integrated circuit (ASIC), a field programmable gate array (FPGA), and the like) and/or in the form of other types of electronic circuitry. For example, the processing may be performed by one or more virtual or physical computer systems (e.g., servers, network storage systems or appliances, blades, etc.) of various forms, such as the computer system described with reference to FIG. 21 below.

Embodiments of the present disclosure include various steps, which have been described above. The steps may be performed by hardware components or may be embodied in machine-executable instructions, which may be used to cause a processing resource (e.g., a general-purpose or special-purpose processor) programmed with the instructions to perform the steps. Alternatively, depending upon the particular implementation, various steps may be performed by a combination of hardware, software, firmware and/or by human operators.

Embodiments of the present disclosure may be provided as a computer program product, which may include a non-transitory machine-readable storage medium embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or standard computer hardware to execute the code contained therein. An apparatus for practicing various embodiments of the present disclosure may involve one or more computers (e.g., physical and/or virtual servers) (or one or more processors within a single computer) and storage systems containing or having network access to computer program(s) coded in accordance with various methods described herein, and the method steps associated with embodiments of the present disclosure may be accomplished by modules, routines, subroutines, or subparts of a computer program product.

FIG. 21 is a block diagram that illustrates a computer system 2100 in which or with which an embodiment of the present disclosure may be implemented. Computer system 2100 may be representative of all or a portion of the computing resources associated with a node of nodes 102 of a distributed storage system (e.g., cluster 101, cluster 235, or a cluster including virtual storage systems 310a-c). Notably, components of computer system 2100 described herein are meant only to exemplify various possibilities. In no way should example computer system 2100 limit the scope of the present disclosure. In the context of the present example, computer system 2100 includes a bus 2102 or other communication mechanism for communicating information, and one or more processing resources (e.g., one or more hardware processor(s) 2104) coupled with bus 2102 for processing information. Hardware processor(s) 2104 may be, for example, one or more general-purpose microprocessors.

Computer system 2100 also includes a main memory 2106, such as a random-access memory (RAM) or other dynamic storage device, coupled to bus 2102 for storing information and instructions to be executed by processor(s) 2104. Main memory 2106 also may be used for storing temporary variables or other intermediate information during execution of instructions to be executed by processor(s) 2104. Such instructions, when stored in non-transitory storage media accessible to processor(s) 2104, render computer system 2100 into a special-purpose machine that is customized to perform the operations specified in the instructions.

Computer system 2100 further includes a read only memory (ROM) 2108 or other static storage device coupled to bus 2102 for storing static information and instructions for processor(s) 2104. A storage device 2110, e.g., a magnetic disk, optical disk or flash disk (made of flash memory chips), is provided and coupled to bus 2102 for storing information and instructions.

Computer system 2100 may be coupled via bus 2102 to a display 2112, e.g., a cathode ray tube (CRT), Liquid Crystal Display (LCD), Organic Light-Emitting Diode Display (OLED), Digital Light Processing Display (DLP) or the like, for displaying information to a computer user. An input device 2114, including alphanumeric and other keys, is coupled to bus 2102 for communicating information and command selections to processor(s) 2104. Another type of user input device is cursor control 2116, such as a mouse, a trackball, a trackpad, or cursor direction keys for communicating direction information and command selections to processor(s) 2104 and for controlling cursor movement on display 2112. This input device typically has two degrees of freedom in two axes, a first axis (e.g., x) and a second axis (e.g., y), that allows the device to specify positions in a plane.

Removable storage media 2140 can be any kind of external storage media, including, but not limited to, hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), USB flash drives and the like.

Computer system 2100 may implement the techniques described herein using customized hard-wired logic, one or more ASICs or FPGAs, firmware or program logic which in combination with the computer system causes or programs computer system 2100 to be a special-purpose machine. According to one embodiment, the techniques herein are performed by computer system 2100 in response to processor(s) 2104 executing one or more sequences of one or more instructions contained in main memory 2106. Such instructions may be read into main memory 2106 from another storage medium, such as storage device 2110. Execution of the sequences of instructions contained in main memory 2106 causes processor(s) 2104 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 2110. Volatile media includes dynamic memory, such as main memory 2106. Common forms of storage media include, for example, a flexible disk, a hard disk, a solid-state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 2102. Transmission media can also take the form of acoustic or light waves, such as those generated during radio-wave and infra-red data communications.

Various forms of media may be involved in carrying one or more sequences of one or more instructions to processor(s) 2104 for execution. For example, the instructions may initially be carried on a magnetic disk or solid-state drive of a remote computer. The remote computer can load the instructions into its dynamic memory and send the instructions over a telephone line using a modem. A modem local to computer system 2100 can receive the data on the telephone line and use an infra-red transmitter to convert the data to an infra-red signal. An infra-red detector can receive the data carried in the infra-red signal and appropriate circuitry can place the data on bus 2102. Bus 2102 carries the data to main memory 2106, from which processor(s) 2104 retrieve and execute the instructions. The instructions received by main memory 2106 may optionally be stored on storage device 2110 either before or after execution by processor(s) 2104.

Computer system 2100 also includes a communication interface 2118 coupled to bus 2102. Communication interface 2118 provides a two-way data communication coupling to a network link 2120 that is connected to a local network 2122. For example, communication interface 2118 may be an integrated services digital network (ISDN) card, cable modem, satellite modem, or a modem to provide a data communication connection to a corresponding type of telephone line. As another example, communication interface 2118 may be a local area network (LAN) card to provide a data communication connection to a compatible LAN. Wireless links may also be implemented. In any such implementation, communication interface 2118 sends and receives electrical, electromagnetic or optical signals that carry digital data streams representing various types of information.

Network link 2120 typically provides data communication through one or more networks to other data devices. For example, network link 2120 may provide a connection through local network 2122 to a host computer 2124 or to data equipment operated by an Internet Service Provider (ISP) 2126. ISP 2126 in turn provides data communication services through the worldwide packet data communication network now commonly referred to as the “Internet” 2128. Local network 2122 and Internet 2128 both use electrical, electromagnetic or optical signals that carry digital data streams. The signals through the various networks and the signals on network link 2120 and through communication interface 2118, which carry the digital data to and from computer system 2100, are example forms of transmission media.

Computer system 2100 can send messages and receive data, including program code, through the network(s), network link 2120 and communication interface 2118. In the Internet example, a server 2130 might transmit a requested code for an application program through Internet 2128, ISP 2126, local network 2122 and communication interface 2118. The received code may be executed by processor(s) 2104 as it is received, or stored in storage device 2110, or other non-volatile storage for later execution.

All examples and illustrative references are non-limiting and should not be used to limit the claims to specific implementations and examples described herein and their equivalents. For simplicity, reference numbers may be repeated between various examples. This repetition is for clarity only and does not dictate a relationship between the respective examples. Finally, in view of this disclosure, particular features described in relation to one aspect or example may be applied to other disclosed aspects or examples of the disclosure, even though not specifically shown in the drawings or described in the text.

The foregoing outlines features of several examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
maintaining, by a storage system, a bucket containing a plurality of objects, wherein each of the plurality of objects has one or more object versions;
creating, by the storage system, a snapshot of the bucket by adding a snapshot entry including a snapshot identifier (ID) and a snapshot time indicator to a snapshot metafile; and
after creation of the snapshot, protecting, by the storage system, those of the one or more object versions of respective objects of the plurality of objects existing at a specific point in time indicated by the snapshot time indicator.

2. The method of claim 1, wherein the snapshot comprises a manual snapshot in which the snapshot time indicator is specified by a requestor of the snapshot.

3. The method of claim 2, wherein the snapshot time indicator comprises a timestamp and wherein the manual snapshot comprises a retroactive snapshot in which the timestamp is earlier than a current system time of the storage system.

4. The method of claim 1, wherein said protecting comprises one or more of:
prohibiting, by the storage system, deletion or modification of object index nodes (inodes) and associated blocks for those of the one or more object versions of the respective objects;
prohibiting, by the storage system, deletion or modification of system metadata from object inodes for those of the one or more object versions of the respective objects; and
prohibiting, by the storage system, deletion or modification of index node (inode) labels of object inodes for those of the one or more object versions of the respective objects.

5. The method of claim 1, wherein a given object of the plurality of objects having a deletion timestamp set is considered a hidden object and wherein the method further comprises excluding from said protecting hidden objects in which the respective deletion timestamp is earlier than the snapshot timestamp.

6. A non-transitory machine readable medium storing instructions, which when executed by one or more processing resources of a storage system, cause the storage system to:
maintain a bucket containing a plurality of objects, wherein each of the plurality of objects has a current version;
create a snapshot of the bucket by adding a snapshot entry including a snapshot identifier (ID) and a snapshot time indicator to a snapshot metafile; and
after creation of the snapshot, protect those of the current versions of the plurality of objects existing within the bucket at a specific point in time indicated by the snapshot time indicator.

7. The non-transitory machine readable medium of claim 6, wherein the snapshot comprises a manual snapshot in which the snapshot time indicator is specified by a requestor of the snapshot.

8. The non-transitory machine readable medium of claim 7, wherein the snapshot time indicator comprises a timestamp and wherein the manual snapshot comprises a retroactive snapshot in which the timestamp is earlier than a current system time of the storage system.

9. The non-transitory machine readable medium of claim 6, wherein the snapshot comprises a scheduled snapshot that is automatically created by the storage system in accordance with a predefined or configurable schedule.

10. The non-transitory machine readable medium of claim 6, wherein protecting those of the current versions of the plurality of objects comprises one or more of:
prohibiting deletion or modification of object index nodes (inodes) and associated blocks for those of the current versions of the plurality of objects;
prohibiting deletion or modification of system metadata from object inodes for those of the current versions of the plurality of objects; and
prohibiting deletion or modification of index node (inode) labels of object inodes those of the current versions of the plurality of objects.

11. The non-transitory machine readable medium of claim 6, wherein a prior version of a given object of the plurality of objects having a deletion timestamp set is considered a hidden object and wherein the instructions further cause the storage system to exclude from protection hidden objects in which the respective deletion timestamp is earlier than the snapshot timestamp.

12. A storage system comprising:
one or more processing resources; and
instructions that when executed by the one or more processing resources cause the storage system to:
maintain a bucket containing a plurality of objects, wherein each of the plurality of objects has one or more object versions;
create a snapshot of the bucket by adding a snapshot entry including a snapshot identifier (ID) and a snapshot time indicator to a snapshot metafile; and
after creation of the snapshot, protect those of the one or more object versions of respective objects of the plurality of objects representing a current version at a specific point in time indicated by the snapshot time indicator.

13. The storage system of claim 12, wherein the snapshot comprises a manual snapshot in which the snapshot time indicator is specified by a requestor of the snapshot.

14. The storage system of claim 13, wherein the snapshot time indicator comprises a timestamp and wherein the manual snapshot comprises a retroactive snapshot in which the timestamp is earlier than a current system time of the storage system.

15. The storage system of claim 12, wherein said protecting comprises one or more of:
prohibiting, by the storage system, deletion or modification of object index nodes (inodes) and associated blocks for those of the one or more object versions of the respective objects;
prohibiting, by the storage system, deletion or modification of system metadata from object inodes for those of the one or more object versions of the respective objects; and
prohibiting, by the storage system, deletion or modification of index node (inode) labels of object inodes for those of the one or more object versions of the respective objects.

16. A method comprising:
maintaining, by a storage system, a bucket containing a plurality of objects, wherein each of the plurality of objects has one or more object versions;
maintaining, by the storage system, a snapshot entry within a snapshot metafile for each snapshot of a plurality of snapshots of the bucket, wherein the snapshot entry includes a snapshot identifier (ID) and a snapshot time indicator; and
after receiving, by the storage system, a request that would result in deletion of a particular version of the one or more object versions of a given object of the plurality of objects, prior to deleting the particular version, determining whether the particular version is protected by one or more snapshots of the plurality of snapshots by comparing one or more time indicators of the particular version to the respective snapshot time indicators of the one or more snapshot entries for the one or more snapshots.

17. The method of claim 16, further comprising permitting, by the storage system, deletion of the particular version to proceed based on a determination that the particular version is not protected.

18. The method of claim 16, further comprising marking the particular version as hidden externally but retaining the particular version internally based on a determination that the particular version is protected.

19. The method of claim 18, wherein the particular version is marked as hidden by setting a deletion timestamp of the particular version.

20. The method of claim 16, wherein the snapshot ID comprises a snapshot name, wherein the snapshot time indicator comprises a snapshot timestamp, and wherein the snapshot metafile is dual-indexed by snapshot names and snapshot timestamps.

21. A non-transitory machine readable medium storing instructions, which when executed by one or more processing resources of a storage system, cause the storage system to:
maintain a bucket containing a plurality of objects, wherein each of the plurality of objects has one or more object versions;
maintain a snapshot entry within a snapshot metafile for each snapshot of a plurality of snapshots of the bucket, wherein the snapshot entry includes a snapshot identifier (ID) and a snapshot time indicator; and
after receiving a request that would result in deletion of a particular version of the one or more object versions of a given object of the plurality of objects, prior to deleting the particular version, determine whether the particular version is protected by one or more snapshots of the plurality of snapshots by comparing one or more time indicators of the particular version to the respective snapshot time indicators of the one or more snapshot entries for the one or more snapshots.

22. The non-transitory machine readable medium of claim 21, wherein the instructions further cause the storage system to allow deletion of the particular version to proceed based on a determination that the particular version is not protected.

23. The non-transitory machine readable medium of claim 21, wherein the instructions further cause the storage system to mark the particular version as hidden externally but retain the particular version internally based on a determination that the particular version is protected.

24. The non-transitory machine readable medium of claim 23, wherein the particular version is marked as hidden by setting a deletion timestamp of the particular version.

25. The non-transitory machine readable medium of claim 21, wherein the snapshot ID comprises a snapshot name, wherein the snapshot time indicator comprises a snapshot timestamp, and wherein the snapshot metafile is dual-indexed by snapshot names and snapshot timestamps.

26. A storage system comprising:
one or more processing resources; and
instructions that when executed by the one or more processing resources cause the storage system to:
maintain a bucket containing a plurality of objects, wherein each of the plurality of objects has one or more object versions;
maintain a snapshot entry within a snapshot metafile for each snapshot of a plurality of snapshots of the bucket, wherein the snapshot entry includes a snapshot identifier (ID) and a snapshot time indicator; and
after receiving a request that would result in deletion of a particular version of the one or more object versions of a given object of the plurality of objects, prior to deleting the particular version, determine whether the particular version is protected by one or more snapshots of the plurality of snapshots by comparing one or more time indicators of the particular version to the respective snapshot time indicators of the one or more snapshot entries for the one or more snapshots.

27. The storage system of claim 26, wherein the instructions further cause the storage system to allow deletion of the particular version to proceed based on a determination that the particular version is not protected.

28. The storage system of claim 26, wherein the instructions further cause the storage system to mark the particular version as hidden externally but retain the particular version internally based on a determination that the particular version is protected.

29. The storage system of claim 28, wherein the particular version is marked as hidden by setting a deletion timestamp of the particular version.

30. The storage system of claim 26, wherein the snapshot ID comprises a snapshot name, wherein the snapshot time indicator comprises a snapshot timestamp, and wherein the snapshot metafile is dual-indexed by snapshot names and snapshot timestamps.
